(19) United States
(12) Patent Application Publication
(10) Pub. No.: US 2012/0163981 A1
(43) Pub. Date: Jun. 28, 2012

(54) METHOD AND COATING FOR PROTECTING AND REPAIRING AN AIRFOIL SURFACE

(76) Inventor: Shek C. Hong, Glastonbury, CT (US)

(21) Appl. No.: 13/332,770

(22) Filed: Dec. 21, 2011

Related U.S. Application Data
(60) Provisional application No. 61/460,046, filed on Dec. 22, 2010.
(60) Provisional application No. 61/460,047, filed on Dec. 22, 2010.
(60) Provisional application No. 61/460,473, filed on Jan. 3, 2011.
(60) Provisional application No. 61/516,036, filed on Mar. 28, 2011.

(51) Int. Cl. F01D 5/14; B05C 9/10; B05D 1/36; B05D 1/02; B32B 37/02; B32B 37/14

(52) U.S. Cl. 416/224; 156/280; 156/278; 427/402; 118/72

(57) ABSTRACT

Disclosed is a field repairable coated airfoil such as a wing or a rotor blade having a leading edge protected by a spray applied or prefabricated variable thickness, multilayer coating system composed a primer or adhesive layer, a basecoat layer and a topcoat where the coating is continuously tapering having a thicker cross section at the leading edge and a thinner cross section at the trailing edge of the airfoil.

### CROSS REFERENCE TO RELATED APPLICATION

This patent application claims priority under 35 U.S.C. §119(e) of U.S. Provisional Patent Application Ser. Nos.: 61/460,046 and 61/460,047 filed on Dec. 22, 2010; 61/460,473 filed on Jan. 3, 2011; 61/516,036 filed Mar. 28, 2011. The disclosure of each of the foregoing patent applications is incorporated by reference herein in its entirety to provide continuity of disclosure.

### FIELD OF THE INVENTION

This invention relates to the application of elastomeric coatings on a curved surface and repair of erosion or impact damage to the elastomeric coatings, particularly such curved surfaces as the leading edge of the airfoil which may take the form of a wing, a rotor blade, a turbine blade, a propeller blade, a fan blade, an aircraft radome, antenna or other structures which have similar arcuate leading surfaces. The method is also useful for other flat and contoured surfaces.

### BACKGROUND OF THE INVENTION

Elastomeric polymeric compositions are used to protect structures with forward facing surfaces, such as wings, rotor blades, propeller blades, fan blades, turbine blades, aircraft radome, and aircraft antennas. These structures can be severely damaged when used in their intended operational environments. The term “erosion damage” is a broad term encompassing damage caused by rain erosion, sand and dust erosion as well as impact damages caused by stone, gravel or foreign objects encountered typically in flight conditions.

Traditionally, helicopter rotor blades and fixed wing aircraft leading edges are protected with a flat polyurethane tape of uniform thickness and color, and a clear pressure sensitive adhesive underneath the tape. Example of this type of erosion protection is the use of polyurethane tape manufactured by 3M Company. The tape is a flat strip with uniform thickness. When it is bent over the nose (tip) of the leading edge, it creates internal stress at the leading edge, which in turn will cause early erosion failure. Currently available elastomeric polyurethane coatings used in erosion protection application are highly sand erosion resistant, demonstrating higher sand erosion resistance than metal. However, elastomeric polyurethane coatings have lower rain erosion resistance than metal, usually exhibiting rain erosion damage in the form of deep pits, cracks, craters, and holes. The size, shape and location of the damage sites vary depending on the nature of the damage. The size and shape can vary from crack lines as thin as hair lines, pits about 1 mini-meter or smaller in diameter, craters about 2 to 3 mini-meter in diameter, or irregularly shaped holes wider than 1 centimeter across. The damage sites can exist isolated and randomly distributed, or continuous across the forward facing surfaces.

When these erosion damages occur, it is extremely difficult to conduct repairs on the rain eroded polyurethane elastomers. The high sand erosion resistance makes it extremely difficult to remove the coatings by hand sanding. For helicopters, removal of the current types of erosion protection coating by mechanical or chemical means requires the removal of the rotor blades from the aircraft and typically removal by machine sanding or other techniques. The reapplication of the tape, boot and sprayable coatings in the field is very labor intensive and costly.

Another method to remove the damaged coating uses chemical strippers. This method also requires the removal of the rotor blades from the aircraft, as the open air will dry out the chemical stripper very quickly. Another problem is that chemical stripping introduces hazardous chemicals into the operation. In addition, typical erosion resistant coatings are used at a thickness equal or greater than 0.006″, more often 0.010″ to 0.014″. Preformed boot, sheets and tapes sometimes can be thicker than 0.020″ or 0.050″. It usually takes overnight soaking to soften the coatings so that they can be removed. There are also concerns that the stripper solution may swell and damage the composite structure under the erosion resistant coatings. For these reasons, it is not practical to do field repair with chemical stripper.

Possible methods that could be used to repair the erosion damage involve brushing on repair material and spraying on the repair materials or patching up with tapes or sheets. Neither of these methods is entirely satisfactory to fill in the cracks, holes of varying sizes and shapes on a curved surface, while still maintaining a smooth, aerodynamic surface at the end of the repair operations. The extra layers simply follow the irregular contours of the damaged surfaces interfering with aerodynamics of the airfoil. None of the methods employed to date have satisfactorily provided a method to field repair a rotor blade which has erosion damage.

It is an object of this invention to provide the designs of a field repairable coated airfoil having a leading edge protected by a sprayed-on multilayer coating system, or a prefabricated multilayer, erosion resistant protection system. The layers may be of generally uniform thickness or preferably a tapered thickness construction with greater thickness on the leading edge of the airfoil. It is an object of this invention to provide a design of the multi-layered coating system with tapered thickness for the overall coating system and also for the individual layers. The total coating thickness of the combined layers may range from 0.005″ to 0.250″ (inches), most preferably in the range of 0.008″ to 0.060″, even more preferably in the range of 0.010″ to 0.040″. The tapered coating structure will have thicker layers at or around the leading edge and then gradually taper to very thin thickness toward the trailing edge. The reduced thickness at the trailing edge will reduce the negative impact of the erosion protection layers on the aerodynamic performance of the airfoils, such as helicopter rotor blades.

The prefabricated article, when assembled on a leading edge of an airfoil, will preferably contain three layers of coating system, comprising a layer of primer or adhesive above the substrate, an intermediate middle layer (basecoat layer), and a top layer or topcoat. If the prefabricated article already contains a primer or adhesive layer, and further bonded with an additional layer of primer or adhesive to the airfoil substrate, the two primer or adhesive layers are regarded as one single layer for its functional purpose.

The three layered coating system may have sand erosion resistant basecoat and topcoat, but more preferably the design contains sand erosion and rain erosion resistant topcoat, and rain erosion resistant, but hand sandable basecoat. It is preferable to have the basecoat occupy at least 50% of the basecoat and topcoat coating thickness.

The prefabricated multilayer erosion protection system may be provided to the end user as a two layered article, consisting of an intermediate middle layer (basecoat), and a top layer (or topcoat) layer, or an intermediate middle layer (basecoat), and a bottom layer (primer) More preferably it is a three layer system consisting of a primer (adhesive) layer, an intermediate middle layer (basecoat), and a top layer (or topcoat) layer. In both cases, the prefabricated articles are bonded to the airfoil leading edge substrates by the use of an additional primer or adhesive. The three layered erosion protection system may also be sprayed on the airfoil directly and be formed as part of the airfoil structure.

It is an object of this invention to provide an erosion protection system based on sprayed coating system, or prefabricated boot, sheet and tape, whose erosion damages such as pits, cracks, craters, and holes of varying sizes and shapes can be easily repaired by hand sanding without power tools, using the repair method disclosed in U.S. patent application Ser. No. 11/640,050 which incorporated herein by reference in its entirety.

It is another object of this invention is to provide a method of repairing airfoil structures such as the rotor blades that can be accomplished in the field. More preferably, the repair to the rotor blade can be done while the blade is still mounted on the aircraft or equipment. Most preferably, the erosion protection system can be removed and/or repaired in the field, without power tools or chemical strippers.

It is another object of this invention to provide an erosion protection boot, sheet and tape system for airfoils with contrasting colors to allow early detection of erosion, impact and other damages and to allow fast repair to lengthen the service life of the blades or structures. The three layers may be of the same colors with different shades, or more preferably with three different contrasting colors to form an early erosion warning indicator system. A preferred tricolor system may be selected from a primer/adhesive of Color A (green, blue, red or yellow), a basecoat (intermediate middle layer) of Color B (gray) and a top layer (or topcoat) of Color C (matte black). Other color combinations can also be used to show the degree of erosion damage in progress.

### SUMMARY OF THE INVENTION

One embodiment of the invention relates to a new method of protecting an airfoil substrate against sand and rain (water, liquid particle) erosion damage and gravel impact damage by forming a tapered multilayer elastomeric coating system directly on an airfoil substrate using spraying process, said multi-layered coating system comprising a primer, basecoat, and a topcoat, said topcoat has high sand and rain erosion resistance and said basecoat has high rain erosion resistance, but low sand erosion resistance (hand sandable); said tapered multilayercoating system is field repairable by hand sanding without the use of power tool. The multilayer coating system has tapered overall thickness varying from thickest at or around the leading edge and thinning progressively away from the leading edge area. The tapered thickness can have reduced weight overall, while still maintaining sufficient erosion protection against rain, sand and impact damages. It also improves the aerodynamic performance of the coated airfoil.

Another embodiment of the invention relates to a new method of protecting an airfoil substrate against sand and rain erosion damage and gravel impact damage by forming a tapered multi-layered elastomeric coating system directly on an airfoil substrate using spraying process, said multi-layered coating system comprising contrasting colors to assist the detection of erosion damages, including a primer of first color, a basecoat of second color and a topcoat of third color; said contrasting colors form the Early Erosion Warning Indicator System to improve the efficiency of airfoil repair and maintenance. The Early Erosion Warning Indicator System has the elastomeric basecoat of a contrasting color to the color of the topcoat layer which is visible on the outer surface. This system of contrasting colored coating layers provides visual detection of any damage by detecting the appearance of the contrasting color the underlying layers thereby indicating damage in the area. In another related aspect, there are three contrasting colored layers (a) a primer/adhesive of a first color applied directly on a structural substrate of said airfoil surrounding a leading edge of said airfoil; (b) a basecoat or repair basecoat of a second color applied over said primer/adhesive; and (c) a topcoat of a third color on top of said basecoat, wherein said first color, second color and third color are contrasting colors allowing visual detection of damage to said protection coating by visual inspection to detect the appearance of the second color of said basecoat or first color of said primer indicating damage in the area. The contrasting colored coating system is used in a method of detecting damage to an airfoil erosion protection coating allowing the slight damage to be repaired before the airfoil substrate is damaged, thereby prolonging service life.

Still another embodiment of the invention relates to a tapered multilayered article in the form of boot, sheet or tape, that is fabricated through the process of spraying, molding, extrusion, calendaring, lamination, etc; said tapered multi-layered article can be adhesive bonded to the airfoil substrate to protect the airfoil against sand and rain erosion damage and gravel impact damage.

Still another embodiment is directed to a method of making an airfoil leading edge erosion protection coating capable of being field repairable by hand sanding comprising applying to an airfoil substrate a coating system composed of a hand sandable basecoat and a topcoat, said basecoat being of lower sand erosion resistance than the topcoat and said basecoat constituting at least 50% of the total coating thickness. A related aspect relates to repairing said erosion protection coating by sanding the damage cavities; applying a repair basecoat to fill said plurality of cavities to form filled cavities; and finally applying a repair topcoat layer over the filled cavities.

Still another embodiment is a field repairable preformed boot, sheet or tape composition positioned on and adhered to a leading edge surface of an airfoil comprising an elastomeric base composition loaded with fillers sufficient to render the boot, sheet or tape hand sandable, said base elastomeric base composition tested in accordance with ASTM D412-92 prior to incorporation of said fillers having a minimum tensile strength of 1000 psi, an elongation at break of at least 200%, and a Shore A hardness of less than 95 A.

A further embodiment is directed to a repairable elastomeric coating or a preformed boot, sheet or tape for a leading edge surface of an airfoil comprising (a) an elastomeric, hand sandable basecoat disposed surrounding said leading edge surface having a sand erosion rate above 0.020 grams/cm²; and (b) an elastomeric topcoat disposed on top of said elastomeric basecoat having a sand erosion rate below 0.020 grams/cm². Preferably the basecoat constitutes at least 50% of the total coating thickness.

Still another embodiment of the invention relates to repairing an airfoil surface protected with sprayed on coating or preformed boot or sheet or tape having a plurality of damage cavities caused by erosion or impact damage comprising filling said plurality of damage cavities in said surface with a liquid repair material using a flexible applicator capable of conforming to the surface of said airfoil surface while being drawn lengthwise along the airfoil surface. This method may include the preliminary steps of sanding the portion of said airfoil surface containing said plurality of damage cavities with abrasive material and applying an optional primer/adhesive coat over sanded areas. The liquid repair material is preferably formulated as an elastomeric hand sandable basecoat and an erosion resistant topcoat may optionally be applied over the basecoat. The erosion resistant topcoat is preferably more sand erosion resistant than the underlying elastomeric basecoat.

Still another embodiment of this invention related to the methods of repairing the sand and rain erosion damage and gravel impact damage with the use of repair kits comprising some or all of items including repair primer, elastomeric repair basecoat, flexible applicator for basecoat capable of conforming to a leading edge surface of an airfoil, elastomeric repair topcoat, sanding supplies, sanding screen, spray gun, wiping solvent, special brushes, wiping towels; said repair topcoat is more sand erosion resistant than the repair basecoat.

Still another embodiment of this invention related to the methods of repairing the sand and rain erosion damage and gravel impact damage with the use of repair kits comprising some or all of items including repair primer, elastomeric repair basecoat, flexible applicator for basecoat capable of conforming to a leading edge surface of an airfoil, elastomeric repair topcoat, sanding supplies, sanding screen, spray gun, wiping solvent, special brushes, wiping towels; said repair primer, repair basecoat and repair topcoat possessing the same contrasting colors as in the coated airfoil to maintain the Early Erosion Warning Indicator System to improve the efficiency of airfoil repair and maintenance.

An additional embodiment relates to an airfoil repair kit comprising a flexible applicator capable of conforming to a leading edge surface of an airfoil; and at least one an elastomeric, hand sandable repair material along with optional kit components of sanding supplies, sanding screen, a syringe or other device for delivering controlled amount of water into repair basecoat or repair topcoat, a primer, an elastomeric repair basecoat, an elastomeric repair topcoat, wiping solvent, brushes, and a sprayer.

An additional embodiment relates to an airfoil repair kit comprising a flexible applicator capable of conforming to a leading edge surface of an airfoil; and at least one an elastomeric, hand sandable basecoat repair material along with optional kit components of sanding supplies, a primer or adhesive, a preformed boot or sheet, or tape, an elastomeric topcoat, brushes, a putty knife, and an optional sprayer.

An additional embodiment relates to an airfoil repair kit comprising at least one elastomeric, hand sandable repair material along with optional kit components of a primer or adhesive, a preformed boot or sheet or tape,

Still another embodiment of this invention related to the incorporation of a separate device such as syringe to introduce moisture on demand into the repair basecoat and repair topcoat; said device enabled the control of pot life of the repair basecoat and repair topcoat in diverse environments with high and low humidity.

It is understood that, in the various embodiments described in this patent application, the hand sandable basecoat composition may take the form of a sprayable coating, a preformed sheet, a boot or a tape. The primer may take the form of a liquid brushable primer or adhesive, a liquid sprayable primer or adhesive, or in the form of a liquid or solid adhesive with or without a gap spacer such as fabric or open mesh. A repair basecoat may take the form of a liquid brushable coating and a repair topcoat may take the form of a brushable or sprayable liquid coating. To form the early erosion indicator system, each of these components may be colored to form contrasting colors when they are deposited or formed onto the substrates.

### BRIEF DESCRIPTION OF THE DRAWINGS

FIG. 1 is partial section of the leading edge portion of an airfoil structure showing sand and water erosion damage.

FIG. 2 is a partial section of the leading edge portion of an airfoil structure showing more severe sand and water erosion damage.

FIG. 3 is a partial section of the leading edge portion of an airfoil structure used for laboratory testing coated with elastomeric erosion coating.

FIG. 4 is a cross sectional schematic view of an airfoil shape with major airfoil or hydrofoil elements identified.

FIG. 5 is a perspective view of a leading edge being repaired using a flexible applicator.

FIG. 6 is cross sectional view of the 3-layer erosion cover taken perpendicular to the leading edge of a helicopter rotor blade showing the embodiment of the tapered basecoat layer of the erosion coating with thickest section at the leading edge becoming thinner away from leading edge area.

FIG. 7 is a plan view of an open grid sanding screen for removal of debris during repair.

FIG. 8 is a cross sectional view of the 3-layer erosion cover taken perpendicular to the leading edge of a helicopter rotor blade showing the embodiment of the tapered basecoat layer and the tapered topcoat of the erosion coating with thickest section at the leading edge becoming thinner away from leading edge area.

FIG. 9 is a schematic representation of a method of testing sand erosion resistance.

### DETAILED DESCRIPTION OF THE PREFERRED EMBODIMENTS

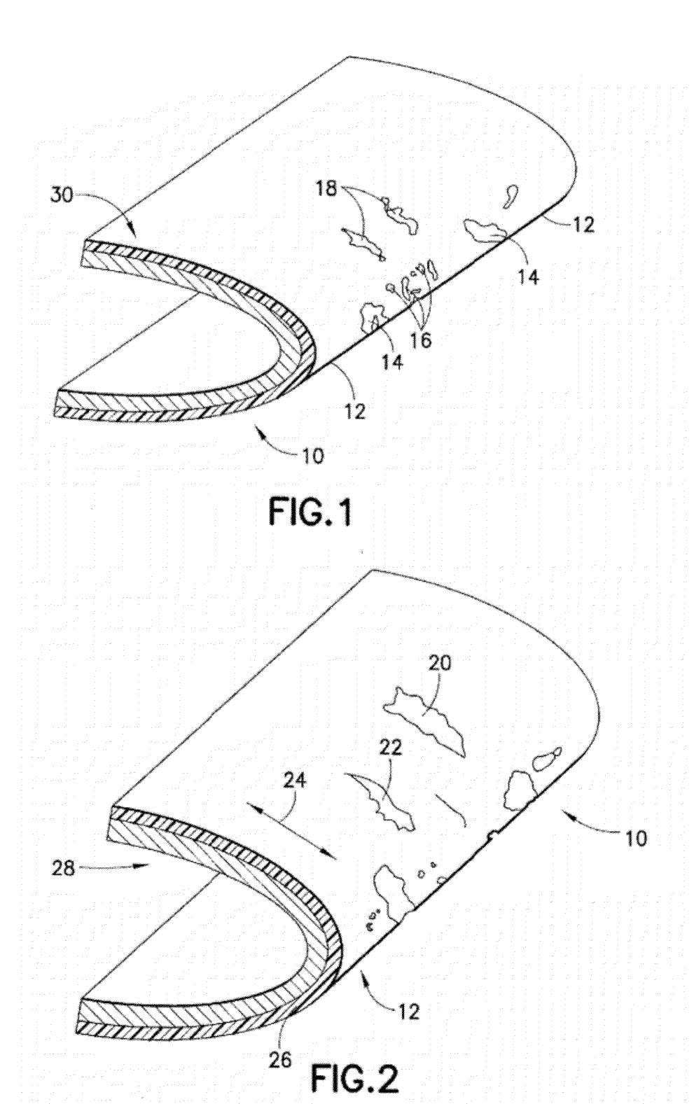

FIGS. 1 and 2 show a time lapse sequence of the erosion damage progression on an airfoil shaped structure 10, the leading edge portion 12 of which is shown in FIGS. 1 and 2 in sectional view. Rain erosion and impact damage (14 and 16) typically occurs at the front of the leading edge 12, while sand or solid particle erosion tends to focus on the contour surfaces slightly away from the leading edges. Rain erosion typically caused pits, craters, and holes, while sand erosion typically produces uniformly matte surface appearance and very shallow erosion hole patterns. FIG. 2 illustrates a later stage of erosion damage using the same section from FIG. 1. In FIG. 2 the most severe erosion sites 20 and 22 occurs when the surface is first eroded by sand or dust particles, and then followed by rain erosion. Under this mixed sand/rain environment, the side surfaces region 24 surrounding the leading edges are typically eroded into deep pits and craters very quickly.

Certain embodiments relate generally to the repair of an elastomeric coating 26 on a curved surface 28 of an airfoil shaped structure 30 as illustrated in FIGS. 1 and 2 as rotor blade 10. The elastomeric coating 26 is defined as a flexible coating based on elastomeric polymer composition. The coating may contain no filler or it may contain fillers. The presence of filler may stiffen up the coatings to the point of relatively little elastomeric physical character, but these filled coatings are still regarded as “elastomeric coatings” for use in various embodiments of this invention. The coating may take in the form of preformed boot, sheet or tape, either adhered directly to the substrate, or with the assistance of a primer and/or an adhesive. The coatings may also be applied onto the substrate by brushing, rolling, spraying, extrusion or adhesive bonding processes.

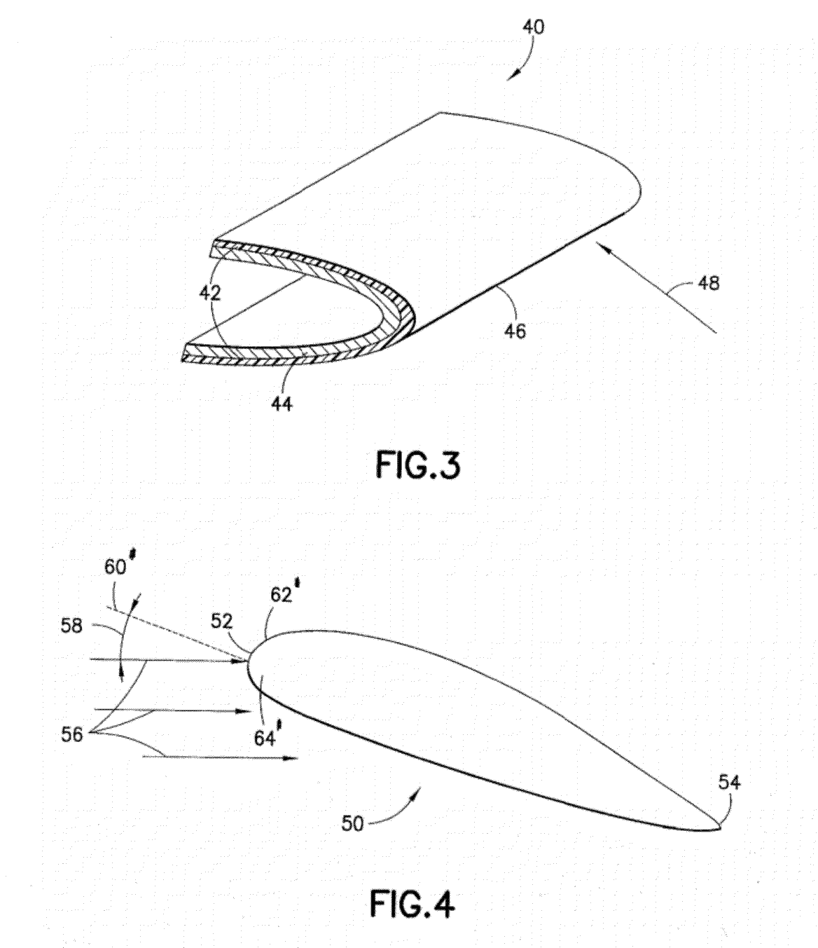

FIG. 3 shows the test airfoil 40 which is a mock-up of the partial airfoil leading edge section of an actual rotor used to simulate actual damage from water and sand impingement in a controlled environment. The elastomeric coating 42 is deposited on the underlying substrate 44 surface area of the whole test airfoil. The leading edge 46 is the focal point for the impingement of water and sand during testing shown by directional arrow 48. All along the leading edge 44 and all the adjacent surfaces represented by this test airfoil damage occurs by the appearance during testing of the erosion damage cavities shown in FIGS. 1 and 2.

FIG. 4 illustrates by a cross-sectional diagrammatic representation of the convention structural portions of a typical airfoil 50 having a leading edge 52 and a trailing edge 54 with the oncoming wind direction shown as arrow 56, the angle of attack 58 is the angle between the wind direction and the chord 60′ of the airfoil 50 shown as a dashed line 60′.

The wind carries sand and rain and debris into contact with the leading edge 52 and impinges on its contoured surfaces 62′ and 64′ on either side of the leading edge. These leading edge areas are the test surfaces simulated by the test airfoil of FIG. 3. and are generally where the damage occurs as best shown in the drawing representations in FIGS. 1 and 2.

### Tapered Thickness Multi-Layer Embodiment

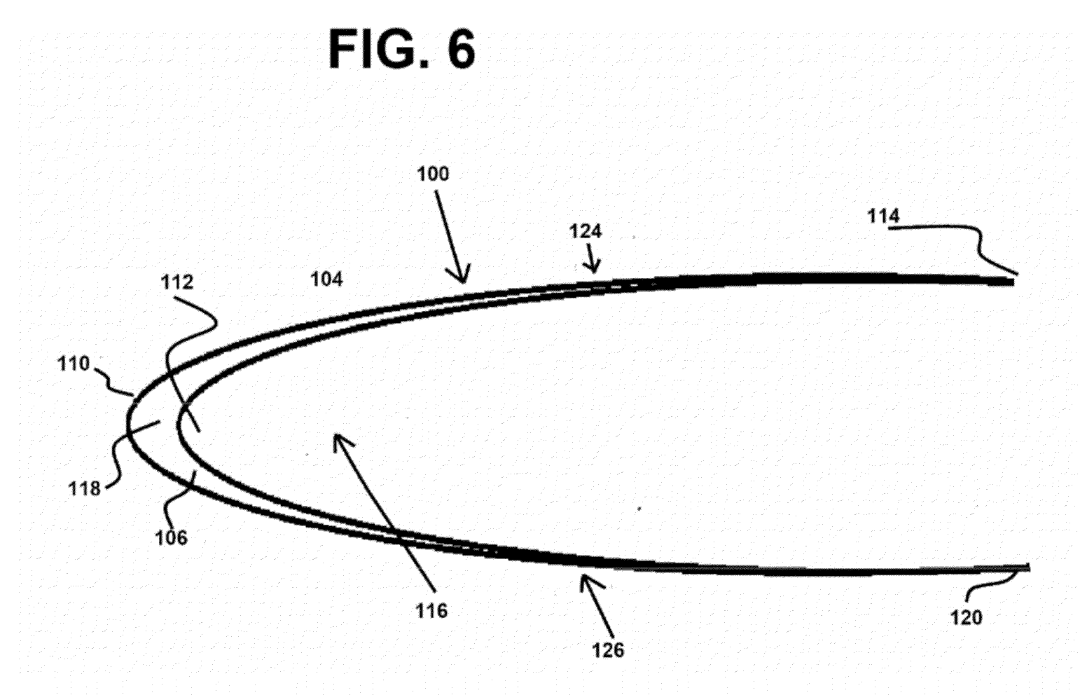

This invention includes various embodiments providing implementation of a new design concept of a tapered, multilayer erosion resistant, field repairable coated airfoil structure. FIG. 6 illustrates a cross section of an erosion resistant coated helicopter rotor blade 100 including the three layered coating system 102 of the invention, comprising a layer 104 of primer or adhesive on the substrate 106, a basecoat 108 constituting the thicker, intermediate layer, and a topcoat 110 or top layer deposited on the leading edge 112 of the rotor which tapers in thickness toward the trailing edge 114 of the rotor blade. The drawing is not to scale, but for use as conceptual visual aid only. Also, the drawing may be symmetrical, but in actual airfoil, it may be symmetrical or asymmetrical depending on the design and location on the airfoil structure. On helicopter rotor blade, the airfoil contour may change continuously from inboard to outboard locations.

The layer 104 consisting of a primer or adhesive can be epoxy, polyurethane, polyvinyl butyral, or any polymer composition that can provide good adhesion between the basecoat 106 (Intermediate or middle layer) and the airfoil substrate 116. If the primer is spray directly onto the airfoil substrate, its thickness is typically in the range of 0.005″ to 0.003, most preferably in the range of 0.008″ to 0.0015″. If it is sprayed onto a preformed boot, sheet or tape, the thickness may be higher to allow sanding to be performed on the preformed boot, sheet or tape before adhesive bonding. Sufficient thickness should be added to compensate for the removal by sanding. It is preferred to have 0.006″ to 0.003″ primer layer left after sanding for easy bonding. If it binding is by the use of adhesive, the adhesive may be in the range of 0.001″ to 0.008″.

The basecoat 106 or intermediate middle layer can be a polyurethane elastomer, fluoro elastomer, or other polymeric composition with high rain erosion resistance, or with good impact absorbing property, or with high rain erosion resistance, but low sand erosion resistance (in this case the intermediate layer may be hand sandable). The intermediate middle layer may contain fillers which may make it hand sandable. The hand sandable definition is described fully in later sections of this specification.

The topcoat 110 or top layer can be a polyurethane elastomer, fluoroelastomer, or other elastomeric polymeric composition with high rain erosion resistance, and preferably also with high sand erosion resistance.

The three layers may be of the same colors, or more preferably with three different contrasting colors to form an early erosion warning indicator system. For example, a tricolor system may be a green or yellow primer or adhesive, a gray basecoat (intermediate middle layer) and a black top layer (or topcoat). Other color combinations can also be used to show the degree of erosion damage in progress.

The preferred tapered thickness for the three layers 104, 106, 110 is as shown in the FIG. 6:

FIG. 6 shows the special heavier thickness 118 at the leading edge 112, where the leading edge typically gets more direct damage from rain erosion and debris impact causing damage to the coating system while in flight operations. The preferred airfoil coating design consists of especially heavier thickness 118 at the leading edge nose and 1 to 2 inches or 1 to 4 inches on both sides of the leading edge 112 or nose of the airfoil. The drawings in FIG. 6 are not to scale. The drawing shows the continuous tapering of the coating thickness from the thickest section 118 to the thinnest section 120 at the trailing edge 114 portion of the airfoil structure. In some embodiments such as illustrated in FIG. 6, the basecoat has the continuously tapered cross section and the topcoat has a relatively uniform cross section.

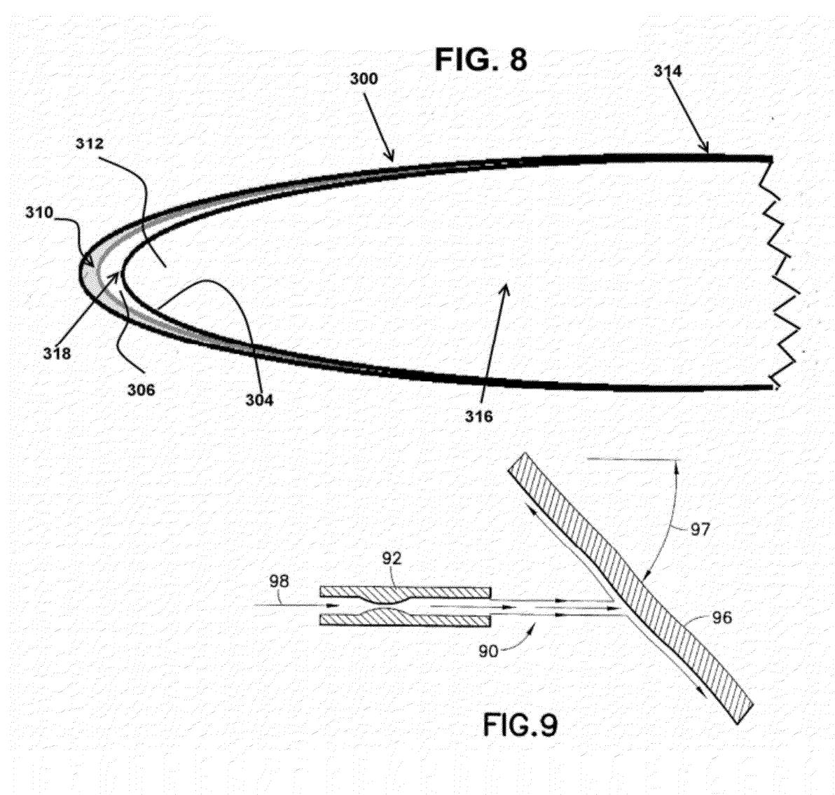

The preferred tapered thickness for both the basecoat 306 and topcoat 310 (shaded layer) are best shown in the FIG. 8. FIG. 8 shows the preferred embodiment with a cross section of a helicopter rotor blade 300, where both the basecoat 306 and topcoat 310 have the continuously variable thickness cross section with the thickest portions 318 overlying the leading edge 312, gradually thinning in cross section towards the trailing edge surface 314 where the protective cover ends. The design allows the first 1 to 4 inches on both sides of the leading edge to be of the same thickness as the nose (tip) of the leading edge, or a slight decrease in thickness through tapering. More preferably, the first 1 to 4 inches away from the nose of the leading edge will have heavier thickness than the trailing edge of the coated area. The precise distance from the nose of the leading edge for maintaining uniform coating thickness and for the start of the tapering may vary depending on the design of each airfoil and the actual erosion pattern in flight. The coating thickness may also start to taper from the nose of the leading edge.

An airfoil such as helicopter rotor blade may show different erosion patterns resulting from sand impacts in the upper 124 and lower 126 airfoil surfaces. The tapering of the thickness may take into account these variations to ensure that sufficient sand erosion resistant topcoat 110 is maintained throughout the sand erosion surface areas. The thickness of the basecoat is also taken into account in the sand erosion prone upper and lower surface areas.

The trailing edge 114 is defined here as the end of the coated area of the airfoil in the direction away from the leading edge. It may end at the actual trailing edge of the airfoil structure, or somewhere in the middle of the airfoil surface, away from the leading edge. The trailing edge 114 location is determined to be the end of the area that is prone to erosion damage.

### Examples of the Three Layer Thickness Profiles

The precise location and coverage area of the multilayer coating on the airfoil is determined by the actual erosion damage patterns experienced by its unique airfoil design. Therefore, each airfoil should be configured specifically for its airfoil design and erosion patterns. The coated area dimension also changes according to its location on the airfoil. For example, a typical helicopter rotor blade has only limited erosion damage in the inboard area, but severe and extensive damages at the outboard area. Therefore, the coated area may occupy less than 10% of the chord length (from leading edge nose to the trailing edge end), but increases gradually along the way when it reaches the outboard end (tip cap), where the coated area may occupy up to 100%. Within these coated area, the coating layer may be tapered to reduce weight, increase aerodynamic performance without reducing erosion protection durability.

The following examples show some of the possible variations of the tapering design. This is to be regarded as for conceptual demonstration purpose only. The precise design needs to be done for each airfoil structure to be coated.

In general, a three-layered coating system may have the topcoat layer in the range of 0.002″ to 0.008″, the basecoat in the range of 0.008″ to 0.250″, more preferably in the range of 0.008″ to 0.060″, even more preferably in the range of 0.010″ to 0.030″, and the primer in the range of 0.0005″ to 0.003″, more preferably 0.0006″ to 0.0015″. If the three layered system is offered as a preformed boot, sheet or tape, the primer may have higher thickness to allow partial thickness removal by sanding during adhesive bonding process. In the tapering design, the primer may be maintained at uniform thickness or tapered, but a uniform thickness is preferred. Although the examples below use 0.001″ as the minimum thickness at the end of the taper, it can actually decrease to zero thickness if needed.

The Top layer (topcoat) in the three layer coating system may be in the range of 0.002″ to 0.008″ thick. The more preferred range is 0.002″ to 0.004″. The lower range of the sand erosion resistant topcoat allows the use of hand sanding to smooth out the damage debris during repair. In addition, the topcoat is typically a thermal insulator. Having topcoat at high thickness interferes with the de-icing system by reducing the efficiency of heat transfer to melt the ice on the airfoil surface.

Due to its relative low thickness, the topcoat 110 can be maintained at about the same thickness throughout the entire coated areas. More preferably it has a tapering thickness, being thickest 118, 318 at the leading edge 112, 312 or nose (tip) of the airfoil and thinnest at the training edge 114, 314 away from the leading edge.

The topcoat may also stop near the middle of the airfoil surface beyond which erosion damage rarely occurs in normal helicopter service. The following examples describe the tapering thickness of the layer over the airfoil surface when measured normal to the leading edge (LE).

Example 1A is 0.002″ to 0.008″ thickness of topcoat at the leading edge (LE), maintaining the same throughout the coated area.

Example 1B: 0.003″ at LE extending 1″ on both sides and tapering off to 0.002″ at the trailing edge.

Example 1C: 0.003″ at LE extending 2″ on both sides and tapering off to 0.002″ at the trailing edge.

Example 1D: 0.003″ at LE extending 3″ on both sides and tapering off to 0.002″ at the trailing edge.

Example 1E: 0.003″ at LE extending 4″ on both sides and tapering off to 0.002″ at the trailing edge.

Example 2A: 0.004″ at LE extending 1″ on both sides and tapering off to 0.002″ at the trailing edge.

Example 2B: 0.004″ at LE extending 2″ on both sides and tapering off to 0.002″ at the trailing edge.

Example 2C: 0.004″ at LE extending 3″ on both sides and tapering off to 0.002″ at the trailing edge.

Example 2D: 0.004″ at LE extending 4″ on both sides and tapering off to 0.002″ at the trailing edge.

Example 2E: 0.004″ at LE extending 1″ on both sides and tapering off to 0.001″ at the trailing edge.

Example 2F: 0.004″ at LE extending 2″ on both sides and tapering off to 0.001″ at the trailing edge.

Example 2G: 0.004″ at LE extending 3″ on both sides and tapering off to 0.001″ at the trailing edge.

Example 2H: 0.004″ at LE extending 4″ on both sides and tapering off to 0.001″ at the trailing edge.

Example 3A: 0.008″ at LE extending 1″ on both sides and tapering off to 0.002″ at the trailing edge.

Example 3B: 0.008″ at LE extending 2″ on both sides and tapering off to 0.002″ at the trailing edge.

Example 3C: 0.008″ at LE extending 3″ on both sides and tapering off to 0.002″ at the trailing edge.

Example 3D: 0.008″ at LE extending 4″ on both sides and tapering off to 0.002″ at the trailing edge.

Example 3E: 0.008″ at LE extending 1″ on both sides and tapering off to 0.003″ at the trailing edge.

Example 3F: 0.008″ at LE extending 2″ on both sides and tapering off to 0.003″ at the trailing edge.

Example 3G: 0.008″ at LE extending 3″ on both sides and tapering off to 0.003″ at the trailing edge.

Example 3H: 0.008″ at LE extending 4″ on both sides and tapering off to 0.003″ at the trailing edge.

Example 4A: 0.008″ at LE extending 1″ on both sides and tapering off to 0.004″ at the trailing edge.

Example 4B: 0.008″ at LE extending 2″ on both sides and tapering off to 0.004″ at the trailing edge.

Example 4C, 0.008″ at LE extending 3″ on both sides and tapering off to 0.004″ at the trailing edge.

Example 4D: 0.008″ at LE extending 4″ on both sides and tapering off to 0.004″ at the trailing edge.

Although 0.001″ is shown as the lowest thickness in the example, the thickness may also be tapered to practically zero thickness. The length to be extended on both sides of the leading edge can also be adjusted according to the actual erosion damage areas.

In the above Examples 1-4, the LE thickness can be selected from any thickness from 0.002″ to 0.008″, and then tapering down to 0.001″ at the trailing edge. In the tapering process, the thickness can be maintained at about the same at the LE and the 1″ to 4″ areas right next to the LE area, more preferably 1″ to 3″ areas, and then tapering down in thickness. It is noted here that the thickness does not have to be precisely 1.0″, 2.0″ or 3.0″ away from the LE. The 1.0″ to 3.0″ values are meant to depict the approximate general area near the nose of the leading edge 112, which incurs much of the rain erosion and gravel impact damages. It will change as the airfoil contour changes which in turn produce different erosion damage patterns on the airfoils. This dynamic adjustment according to the design of the airfoil and leading edge is within the scope of this invention for all the layers of the coating system. It is preferred that the coated area covers at least the erosion damage area plus a degree of safety margin of enlarged area. For the most severe erosion damage area, the coating thickness may be kept at higher uniform thickness until it reaches the area with less erosion damage. An extra safety distance for the uniform thickness area may be added.

It is also noted that the above design fits the typical curvature profiles of the helicopter rotor blade leading edges. For other leading edge structures with broader or slower change in the leading edge curvature, the heavier thickness area may be modified to fit that particular airfoil leading edge. In such cases, the heavier thickness area may be extended to more than 4″ on upper 124 and lower 126 surfaces of the airfoil leading edge. It is also sometimes preferred that the upper 124 and the lower surface 126 may have differing lengths of the thicker coatings. This statement applies to both the topcoat illustrated above and the basecoat described below.

Because the topcoat 110 or top layer is both rain and sand erosion resistant, it preferably should be maintained at a minimum thickness of 0.002″ in the LE area. Where it is encountering heavy sand erosion damages, it is more preferred to maintain a minimum thickness of 0.003″, most preferably about 0.004″ or higher.

The intermediate middle layer (basecoat 106) is preferably 0.008″ to 0.060″ in most cases, but can be as thick as 0.250″.

The middle layer or basecoat 106 may be the same thickness throughout, but preferably it has tapering thickness, being the thickest at the leading edge 112 or nose of the airfoil structure, and thinnest at trailing edge 114 portion of the airfoil structure. The following examples describe the tapering thickness of the layer over the airfoil surface when measured normal to the leading edge (LE) as shown in FIG. 6.

Example 5A: 0.008″ at LE extending 1″ on both sides and tapering off to 0.002″ at the trailing edge.

Example 5B: 0.008″ at LE extending 2″ on both sides and tapering off to 0.002″ at the trailing edge.

Example 5C: 0.008″ at LE extending 3″ on both sides and tapering off to 0.002″ at the trailing edge.

Example 5D: 0.008″ at LE extending 4″ on both sides and tapering off to 0.002″ at the trailing edge.

Example 6A: 0.015″ at LE extending 1″ on both sides and tapering off to 0.002″ at the trailing edge.

Example 6B: 0.015″ at LE extending 2″ on both sides and tapering off to 0.002″ at the trailing edge.

Example 6C: 0.015″ at LE extending 3″ on both sides and tapering off to 0.002″ at the trailing edge.

Example 6E: 0.015″ at LE extending 4″ on both sides and tapering off to 0.002″ at the trailing edge.

Example 7A: 0.020″ at LE extending 1″ on both sides and tapering off to 0.002″ at the trailing edge.

Example 7B: 0.020″ at LE extending 2″ on both sides and tapering off to 0.002″ at the trailing edge.

Example 7C: 0.020″ at LE extending 3″ on both sides and tapering off to 0.002″ at the trailing edge.

Example 7D: 0.020″ at LE extending 4″ on both sides and tapering off to 0.002″ at the trailing edge.

Example 8A: 0.030″ at LE extending 1″ on both sides and tapering off to 0.002″ at the trailing edge.

Example 8B: 0.030″ at LE extending 2″ on both sides and tapering off to 0.002″ at the trailing edge.

Example 8C: 0.030″ at LE extending 3″ on both sides and tapering off to 0.002″ at the trailing edge.

Example 8E: 0.030″ at LE extending 4″ on both sides and tapering off to 0.002″ at the trailing edge.

Example 9A: 0.060″ at LE extending 1″ on both sides and tapering off to 0.002″ at the trailing edge.

Example 9B: 0.060″ at LE extending 2″ on both sides and tapering off to 0.002″ at the trailing edge.

Example 9C: 0.060″ at LE extending 3″ on both sides and tapering off to 0.002″ at the trailing edge.

Example 9D: 0.060″ at LE extending 4″ on both sides and tapering off to 0.002″ at the trailing edge.

In all of the above Examples 5-9 of basecoat thickness, the basecoat is tapered to a thickness chosen from 0.002″ to 0.008″ at the trailing edge. It can also be tapered to practically zero thickness.

In the above Examples 5-9, the basecoat thickness can be any thickness between 0.008″ to 0.0060″, or in extreme erosion service, anywhere between 0.008″ to 0.250″. The above examples cite 0.008″, 0.015″, 0.020″, 0.030″ and 0.060″ as simple round number examples. It is evident that the degree of tapering is a design choice dictated by the severity of the service conditions and is not intended to be limited to the fixed thickness values of the Examples shown above.

It is also noted that the above design Examples 1-9 fit the typical curvature profiles of helicopter rotor blade leading edges thereby not changing the aerodynamic character of the airfoil of the rotor blade. For other leading edge structures (such as windmill blades or aircraft wings) with varying rates of change in the leading edge curvature of the airfoil design, it is understood that the heavier thickness area may be modified to fit any particular airfoil leading edge configuration. In such cases, the heavier thickness area may be extended to more than 4″ on both upper and lower surfaces 124 and 126 of the airfoil leading edge. The upper surface 124 and the lower surface 126 may have different degrees of coverage of the thicker coatings on the upper and lower surfaces 124 and 126 depending upon the erosion damage patterns typical of the service to which the airfoil is subjected.

In all of the above examples, the topcoat (top layer) may preferably extend past the end of the basecoat coverage for an additional 0.25″ or more to seal the basecoat under the topcoat. This has the advantage of reducing any tendency of undesirable lifting of the basecoat away from the airfoil substrate 116, 316 near the trailing edge ending of the basecoat. The airfoil substrate 116, 316 for helicopter rotors are typically complex high performance composite structures made of carbon fiber, glass fiber or aramid (Kevlar) fiber sheets overlying 3 dimensional honeycomb structures made of the same fibers. The leading edges are typically covered by relatively thin sheets of stainless steel, aluminum, nickel-chromium alloys, titanium alloys, and nickel-cobalt alloys or combinations thereof. One significant advantage of the materials of this invention is the excellent adhesion of the multilayer erosion covers to these substrates, particularly to the fiber composite portions of the airfoil substrate surfaces between the leading edge and trailing edge areas of the airfoil.

### Examples of Methods of Forming Tapered Multilayered Coating System

The tapered, multilayer elastomeric erosion protection articles or covers of this invention can be produced by suitable spraying or molding techniques which allow for varying thickness of one or more of the multilayer composites in three dimensional shapes

Forming of the tapered multilayer article can accomplished by repetitively spray applying layers of any or all of the following layers: primer, basecoat and/or topcoat, to a releasable surface having the complementary shape of the airfoil to which it will be later applied, such as the leading edge of a helicopter rotor blade. The preformed multilayer erosion coating article can also be produced by molding in the desired thickness one or more of the primer, basecoat and/or topcoat layers of the multilayered erosion coating system.

### Example 10

### The Spraying Method of Making the Tapered Multilayer Coated Airfoil Articles

The airfoil substrates to be coated are first sanded, solvent wiped, masked and then sprayed with the primer with on spraying pass or more to the desired thickness. After the recommend drying cycle of one hour, the basecoat is sprayed with multiple spraying passes to the desired thickness and taper patterns. After waiting for about 45-60 minutes, the topcoat is sprayed with multiple passes to the desired thickness and taper patterns. The coated airfoil is left to dry under the proper curing temperature (60-100° F. and relative humidity of 30%-70% to dry and cure for 5 days. The coated airfoils are ready for packaging and shipment.

### Example 11

### The Spraying Method of Making the Preformed Multilayer Coating System

Select a release film, release coating, or release agent with suitable surface tension such that the coating and primer can deposit evenly and later release cleanly. Examples of such release film include polyethylene, polypropylene, polyester, and fluoropolymer films Suitable release coating or release agent are those that will not interfere with future adhesive bonding or non-transferable and can be easily sanded off.

Mount the release film over the leading edge, and coating area of any suitable tooling surface which has the same three dimensional surface configuration as the airfoil for which this particular preformed article is designed, or apply the release agent or release coating over the tooling surface

In the case of a helicopter rotor, the forming surface has the same three dimensional shape as the actual rotor blade itself duplicating areas to be coated. Spray the primer to desired thickness and tapering patterns with one or more spray passes operations. Wait for the curing and drying of the primer.

Allow the primer to dry to the touch or to cure as appropriate to develop sufficient solvent resistance.

Spray the basecoat with multiple passes to the desired coating thickness profile and tapering patterns; wait for the basecoat to flash off between each spraying pass.

After the waiting period as per the coating requirement (about one hour), Spray successive passes of the topcoat over the basecoat to develop the desired thickness and tapering profile. Wait for the topcoat to flash off between each spraying pass.

The spraying may be done with human manual spraying or with the help of a robot and computer programmed spraying apparatus. The computer programmed robotic spraying is especially suitable for depositing the varying cross sectional thicknesses of the component layers of the multilayer erosion coating system as it progresses from the leading edge to the trailing edge on the substrate surfaces as shown in FIG. 6.

After the topcoat is sprayed, remove the masking tapes to reveal the clean final coated area on the releasable film.

After drying and curing of the coatings, remove the three layered preformed, procured article from the release film or the tooling surface. Trim to proper size if needed.

The above process forms the prefabricated article for use in erosion protection of the leading edge of an airfoil.

To use the prefabricated article on an airfoil structure, prepare the airfoil surface by proper sanding and solvent wiping.

Prepare the prefabricated article by proper sanding of the primer surface of the article and solvent wiping. It has been determined that there is a special advantage to providing the thin primer surface as part of the prefabricated article. The polyurethane coatings are generally very sand erosion resistant. Having an epoxy primer makes the prefabricated article much easier to sand and prepare for bonding. The sanding of the primer surface is optional, because some primer may be inherently easy to bond without sanding. In such case, solvent wiping will be sufficient.

Apply a thin layer of a bonding adhesive to the clean primer surface and/or the airfoil structure. This can be done with spraying, brushing, rolling or other suitable means.

Apply the prefabricated article to the airfoil structure. Squeeze out any entrapped air bubbles to ensure smooth, bubble-free final assembly.

Let the adhesive cure. The bonded airfoil structure is ready for service against rain erosion, sand erosion and impact damage, and be field repairable.

In the above Example 11, the primer layer can be omitted and a 2-layered article is then produced. When 2-layer article contains only the basecoat and the topcoat, the hand sandable basecoat can be easily sanded to provide the bondable surface to the bonding adhesive used to attach the 2-layer article to the leading edge surface of the airfoil.

In the above Example 11, the topcoat layer can be omitted and a 2-layered article is then produced with primer and basecoat. When 2-layer article contains only the primer and basecoat, the primer can also be easily sanded to provide the bondable surface to the bonding adhesive to attach the 2-layer article to the leading edge surface of the airfoil.

The two layered structure may be further topcoated by brushing, spraying or paintrolling. It may be used as is for special purpose such as just rain erosion protection.

### Example 12

### Other Methods of Making Tapered 3-Layer Erosion Coating

Another method of forming the above tapered 3-layer structure is to form the basecoat layer (intermediate middle layer) by molding in a mold with tapered cavity. A layer of primer is sprayed onto the mold surface and molded together with the elastomeric basecoat. The basecoat s formulated without solvent. The molded boot or sheet can be used as two layered article or further sprayed with the sand erosion resistant topcoat.

In another embodiment, a thin layer of topcoat can be formed on the mold surface first, by spraying, brushing, or casting, then a middle layer (basecoat) is formed over the topcoat. The primer layer can be brushed or sprayed onto the molded article to form the three layered structure. It is understood that the layered structure may include more than 3 layers without deviating from the teaching of this invention.

It is understood that uniform thickness of each layer can be used to form the 2-layered or 3-layered prefabricated article, for applications where uniform thickness is preferred over a tapered thickness profile.

In forming the tapered multi-layered structure, the top layer and the intermediate middle layer can be elastomeric polymers, such as polyurethane/polyurea elastomers, fluoro elastomers, urethane acrylate elastomers, silicone elastomers, and other elastomeric polymers. Polyurethane and polyurea are used interchangeably for this patent application purpose.

Both layers are preferably rain and sand erosion resistant. It is preferred to have the sprayed on or preformed (prefabricated) article configured to have the top layer as a sand erosion resistant and rain erosion resistant elastomer, the intermediate middle layer as a rain erosion resistant, but hand sandable elastomer. The use of hand sandable intermediate middle layer makes it possible to do field repair without the use of power tools. The definition of “hand sandable” in the context of this erosion protection coating system is set forth below and more fully disclosed in prior filed U.S. patent application Ser. No. 11/640,050 which is incorporated by reference in its entirety.

### TERMINOLOGY DEFINITIONS

The term “airfoil” as used throughout this specification is meant to be more expansive than the conventional airfoil shaped structure in FIGS. 4 and 6 and will also encompass structures such as hydrofoils which have an aerodynamic shape that is somewhat different than FIG. 4 but are similarly subject to wind or water carried sand and debris. Additional included shapes are radomes shape which would have a leading edge in the form of a narrowed point rather than the leading edge which is geometrically a line in FIG. 4 airfoil form. Aircraft antennae are shaped to allow smooth airflow around them and are considered within the term “airfoil” as are other devices benefiting from the advancement of the embodiments such as windmill blades, turbine blades, runner blades, fan blades, compressor blades, propeller blades, vanes, stay vanes, hydroelectric turbines, marine propellers, hydro turbines, gas turbines, tide mills, windmill blades, compressor blades, pump impellers, blower blades, impellers, propellers, and many kinds of fans all of which have the common feature of having fluid passing by the surfaces which may carry damaging sand and debris.

The term “leading edge” will similarly be understood to have a broader meaning than shown in FIG. 4 and should be defined as a narrowed surface designed to encounter the wind or other fluid such as water. It is may be an elongated narrowed edge in the case of a rotor blade, wing, antenna, windmill blade or a sharper edge surface as in a propeller blade or a forward wind encountering point area as in a radomes (which may have a blunt conical form or other generally rounded shape).

The term “elastomeric” as used herein generally is understood to be any flexible material which has an ultimate elongation at break as measured by ASTM D412-92 of at least 40% at break, preferably 80% and more preferably 100%.

The terms “sprayable”, “sprayed on”, or “spray-applied” or “sprayed” all are meant to describe materials that are coated or bonded onto a substrate, such as an airfoil, particularly the leading edge and surrounding areas using spray techniques. This terminology distinguishes elastomeric materials that may be applied to the substrate as a premolded and/or preshaped boot of a single layer of elastomeric material, a preformed flat two dimensional tape material which is adhered to the airfoil or a preformed sheet that may be bonded to the airfoil.

The term “precured” means it is a curable elastomer that has been cured into a permanent form. In the case of polyurethane or polyurea elastomers they are reacted with curatives/moisture to cure into solid, permanent form.

The terms “preformed” or “prefabricated” or “preformed and precured” as used herein is understood to mean that the article or multilayer structure being described is permanently shaped into a desired, predetermined permanent three dimensional shape. However, due to the elastomeric nature, a preformed or prefabricated boot, sheet or tape of this invention can still be bendable to fit and bond to curved substrate such as a leading edge of an airfoil.

The term “hand sandable” is understood to mean a material whose surface is abraded away as loose debris within one minute of hand sanding. The hand sanding is done on a properly supported 1.5″×3″ area of the test material using moderate downward pressure with 80 grit aluminum oxide sandpaper. A “hand sandable” coating is characterized by the sample being able to be sanded by hand pressure into powder in less than 30 seconds or preferably less than 15 seconds, Excellent sandability preferably included one or more of the following additional properties: 1) sanding debris is coming off from the coating within 20 seconds, more preferably in less than 10 seconds of sanding, 2) Low friction during sanding, 3) No heat or low heat generation after one minute of hand sanding with normal effort, 4) Loose sanding debris in free flowing powder form, instead of gum up or rolled up agglomerate, 5) the amount of sanding residue on sanding disc is equal to or less than the amount left on the coating after sanding. Using the Particle Erosion Test Apparatus, we have found that materials with sand erosion rate of less than 0.020 grams are difficult to sand by hand. To be hand sandable by the definition of this invention, the material should have a sand erosion rate of higher than 0.020 grams, preferably higher than 0.030 grams and 0.040 grams. Materials having sand erosion rates between 0.020 and 0.030 sometimes exhibit slightly more difficult hand sanding characteristics.

The terms “primer and primer layer” are understood to mean a layer of substantial thickness made from a chemical composition that increases/improves the adhesion between the elastomeric erosion protection materials and the substrate. If the erosion protection material is supplied in the form a preformed boot or sheet, the primer can be an adhesive suitable for bonding the boot or sheet to the substrate. The adhesive may be supplied as brushable liquid or paste, as a dry heat activatable sheet or other suitable forms know in the adhesive industry. In such application, it is understood that the primer (adhesive) may contain an optional layer of gap-controlling material, such as open mesh or fabric, which will serve to control the amount of the adhesive deposited between the erosion protection material and the substrate.

It has been found to be very difficult to repair the pits, craters, and holes scattered throughout the leading edge of a helicopter rotor blade or other leading edge surfaces. Common repair techniques of using a putty knife and putty-like solid repair resin do not work well in this application. The damage sites can be too small for a material with putty consistency to flow in. The putty knife cannot bend over and repair a curved surface either.

A helicopter rotor blade or other leading edge structures are well defined aerodynamically shaped surface. The airfoil shape of the rotor blade is characterized with a very sharp curve at the leading edge. A repair resin must have the proper viscosity so that it does not run or drip from the sharp curve during the repair procedure. Any repair to the blade surface must minimize the distortion of the aerodynamic contour.

The difficulty of repairing a damaged elastomeric surface has limited the total service life of an elastomeric erosion protection system on a helicopter rotor blade. Currently, elastomeric molded boots and self adhesive polyurethane tape are used to protect the blades. Once the damage occurs on surface and in the body of the elastomeric materials, the self adhesive elastomeric tapes may encounter sudden catastrophic adhesion loss and fly away from the rotor blades during flight, which become a safety concern for aerodynamic balance of the rotors. The alternative existing elastomeric covering of a rotor takes the form of a preformed, molded boot that is adhesively bonded to the blade substrate. The elastomeric boot is usually left to erode until not usable and then replaced. Replacing the tape and the boot are both very labor intensive operations, involving the removal of the rotor blade from the helicopter, stripping off all old coatings by a variety of methods, applying some replacement elastomeric materials and then carefully conducting weight balancing of the blade after the repair procedure. If the field unit is not equipped to do the repair, the entire rotor blade must be sent back to a depot facility to do the repair and overhaul. The removal, replacement and transportation of the rotor blades is costly and time consuming.

Another deficiency of the current erosion protection methods is the lack of an early erosion indicator that enables the user to take preventive action to stop the erosion going all the way through the elastomeric coating and ultimately into the substrate. The commercial erosion resistant sprayable coatings use one color gloss or matte color schemes. If a basecoat and a matte topcoat are used, the prior art coating systems typically use a gloss or semi-gloss basecoat, and a matte topcoat, both of the same or very similar colors. In these systems, even though the underlying primer or adhesive of different texture or different colors may be utilized, the total system does not provide sufficient warning for the users to take preventive actions when there is slight damage to the elastomeric coating. Once the underlying primer or adhesive is exposed, the elastomeric protective coating is damaged to the point of not being serviceable any longer. This inability to detect early and slight damage shortens the service life of the rotor blades and other airfoil-type structures with leading edges, such as radomes and antenna structures on the aircraft. Because the prior art elastomeric erosion protection materials typically erode to the substrate with deep cratering and pitting, the damage usually reach the substrate before any corrective actions can be taken. This can be detrimental to a composite structure as the underlying composite layers of the rotor or airfoil can be punctured through by rain erosion in a very short period of time.

Still another deficiency of the existing erosion protection systems is the difficulty of coating removal from the substrate. Coating removal is an essential part of a successful field repair procedure. An elastomeric erosion resistant coating by its nature is very difficult to remove. The common methods use a solvent based stripper to soak through the coating to soften or dissolve the primer. Typical primers suitable for such procedure include polyvinyl butyral based wash primers. While the procedure works well to remove the erosion resistant coatings, the use of excessive amount of hazardous solvents is not desirable. In addition, it takes a long time, typically overnight soaking, to soften or dissolve the primer. In military or other emergency operations, the helicopter cannot be out of service for many hours, waiting for this lengthy repair procedure.

Many advantages can be achieved by the repair methods and procedures in the embodiments described hereafter.

The field repair of the cavities caused by rain erosion or impact damage on the curved surfaces of an airfoil structure can be accomplished with the use of a flexible airfoil contour applicator also called a Flexible Applicator (FA) as described more fully below. Additional steps in the repair of rotor blade damage may include one or more of the following steps: 1) Surface preparation including sanding, 2) Application of primer or adhesive, 3) Application of basecoat, and 4) application of topcoat.

### 1. Surface Preparation Step

On a rain or impact damaged surface, there are holes and cut surfaces, with some remaining debris hanging around the wells of the craters, pits and holes. This “raised” debris must be removed or smoothed to correspond with the surrounding contoured surface. Exacto knives can be used, but are discouraged due to the risk of damage to the composite substrates. We have found that a pair of scissors, most preferably curved scissors, can be used to trim off the raised debris. The curved scissors has a curvature that can touch the damage sites at proper angle to trim off the debris. This is especially helpful in the surface preparation of sand erosion resistant elastomeric erosion protection coatings, since they are very difficult to smooth out with abrasive sanding. For example, elastomeric polyurethane coatings containing no filler or low concentration of fillers tend to “smear” or “gum up” when abrasive sanding is used. These coatings will be extremely tiring for a worker or soldier to sand the large rotor blade in the repair procedure.

### Hand Sandable Embodiment

To be practically repairable in the field, the new erosion protection system of this embodiment should preferably be sandable by hand in the field, on the aircraft, without the need to remove the rotor blade from the aircraft. In one preferred embodiment, the coating is made to be hand sandable on purpose. This is a significant departure from the currently employed erosion protection materials. The conventional erosion protection method strives to make the elastomeric coatings or resins as erosion resistant as possible, thus making the unfilled or lightly filled/pigmented elastomer extremely difficult to remove by sanding when repair is needed. These materials are not “hand sandable” as defined above. This embodiment discloses the opposite concept in the design of the erosion protection system. In this embodiment, additional fillers are added to decrease the sanding resistance of the basecoat on purpose, and in many applications where sand impingement is encountered, a thin layer of sand erosion resistant topcoat is used on top of the sandable basecoat to form the total erosion protection system. In this preferred embodiment, the thin layer of the topcoat and the thick layer of the basecoat can be sanded with the use of proper grade of sanding medium, yet still achieve high erosion protection against rain and sand erosion. By using this new concept with the added early erosion multi-color warning indicator that will be described in detail below, a field repairable, renewable erosion protection system for protection of the leading edges of airfoils is achieved.

On a helicopter rotor blade or other airfoil-type leading edges having very well defined aerodynamic surfaces, conduct of an electrically or pneumatically powered sanding operation is a dangerous procedure as over sanding can easily damage the composite honeycomb structure underneath the composite skin. Electrical or pneumatic power sanding may be used in a depot environment where experienced personnel routinely perform the sanding procedure, but are not practical for a field repair environment where inexperienced personnel are handing the sanding tasks under non-ideal working conditions. It is preferred to use hand sanding because the human hand can sense the contour of the substrate and dynamically adjust the degree of sanding force against the coating for optimum removal without damage to the substrate. Sand paper with grit sizes between 40 to 220 grits may be used, with 80-120 grits especially preferred. A sanding block with proper grade of sand paper and foam sanding pad can also be used. We have found unexpectedly that sanding screens with 80 grits to 220 grits abrasives are especially useful in the removal of topcoat debris. The thin topcoat layer may be eroded by rain and residual edges stay after rain erosion. A normal sand paper can remove the sand erosion resistant topcoat resides pieces, but not very efficiently. The sanding screen was found surprisingly efficient in trapping and removing the small residues of topcoat that remain on top of the basecoat. We have also found that by using sanding screens of 180 grits to 220 grits, we were able to remove the topcoat residues very quickly without damaging the handsandable basecoat. This is a unusual property of the sanding screen that is especially useful for this invention. It is a valuable tool in the repair kits when the repair of the topcoat is involved.

The sanding of the damaged area may create loose coating debris and powders. These loose powders and debris must be removed from the work surface before the repair resins can be applied. To remove the loose debris and powders, it has been found that different solvents have different cleaning power. A good cleaning solvent does not attack or soften the erosion protection elastomers, but is able to pick up the loose powders effectively. Slower evaporating solvent is preferred as the field repair is conducted outdoor in open air. It has been found that non-polar solvents are especially preferred for in the repair procedure of this invention. Lint free wipers are preferred for use with the cleaning solvent in this procedure.

### 2. Application of Primer/Adhesives

If the erosion damage reaches the substrate, an adhesion promoting repair primer is usually required. Afterwards, a hand sandable repair basecoat is applied to fill in the cavities, with the aid of the flexible applicator using the application method of deforming the flexible applicator to conform to the contour of the airfoil allowing the basecoat repair resin to be spread with the flexible applicator into the cavities without leaving repair resin on the undamaged portions of the airfoil surfaces. Once the basecoat is hardened then it is followed by application of the sand erosion resistant Repair Topcoat.

When the primer is eroded and the substrate is exposed, the repair primer, which may be an epoxy primer, must be used with great care and precautions to prevent it from being inadvertently deposited on top of the intact original elastomeric coating. It has been experimentally found that if spots or areas of the epoxy primer are left on top of an elastomeric polyurethane erosion resistant coating, the epoxy primer will cause early erosion initiation, probably due to the stiff, high modulus nature of the epoxy base of the primer which is markedly different from the lower modulus of the basecoat causing stressed to develop at the interface which cause cracks and premature failure of the basecoat integrity. Therefore, the primer must be applied only to the exposed substrate areas at the bottom of the cavities without any primer being overlapped onto the undamaged surrounding elastomeric coating surface.

Because of the typical small size of the rain erosion induced damage cavity, depositing the proper amount of primer is a significant challenge which requires skill and practice to achieve. Most paint brushes used in any normal painting jobs are too big for this procedure. Practice of this embodiment preferably includes the use of micro-sized tips or brushes for the repair of erosion protection system. Especially preferred are the tips or brushes that can control the deposit size to about 1.0 mm, 2.0 mm and 3.0 mm in diameter. These dot-placement brushes are very useful in priming the craters, pits, cracks, and holes. They can also be used to apply the primer to an area larger than craters, pits and small holes. For erosion damages that have enlarged to a somewhat bigger area, small width bristle brush can be used. Examples of suitable applicators for applying the primer are Microtip, Microbrush and Ultrabrush manufactured by Microbrush International, Wisconsin, USA. Other specialty types of brushes manufactured by Designetics of Holland, Ohio are also suitable. The brushes may include foam, bristles, felt, and other synthetic and natural hairs and fibers.

The repair primer may be formulated from suitable known primer bases including but not limited to epoxy, polyvinyl butyral, polyurethane or other polymer system with good adhesion to the substrate. It is preferred to have a fast drying and fast curing primer so that the erosion resistant coatings can be applied on top of the primer within short time such as one to two hours. When priming, with the special micro-sized brushes, the superfine round tip Microbrush is used to deposit micro dots into the small pits and craters. A larger brush is used for spreading the primer onto bigger areas, preferably using about 3/16″ wide strokes to “paint” larger areas with primer. When the primer becomes tack free or cures to proper stage (depending upon the primer base system), it is ready to be coated with the basecoat.

If the hand sandable basecoat takes the form of a preformed boot or sheet, the primer takes the form of an adhesive to bond the preformed boot or sheet to the substrate. The adhesives may have bonding strengths that are classified as “permanent adhesive” or “moderate bonding strength adhesives” that are formulated to be removable. The adhesive may be pressure sensitive or non pressure sensitive. A layer of open mesh or fabric may be used to control the thickness of the adhesive deposited.

### Repair of the Basecoat

The hand sandable basecoat may be supplied in the form of a preformed boot, sheet or tape. In this case, the boot or sheet is made to be hand sandable with the addition of sufficient amount of fillers and the boot or sheet is formed. The methods of forming boot and sheet may include molding, casting, spraying, dipping, brushing and other processes. The preformed boot or sheet may be used to form a new erosion protection system at the blade manufacturer's facility or may be used as field repairable parts. In either case, the hand sandable boot or sheets are bonded to the airfoil substrates by the use of an adhesive, with or without an optional layer of gap-controlling open mesh or fabric, which is used if there is erosion damage on the boot or sheet.

For use as hand sandable repair basecoat to repair the hand sandable boot or preformed sheet, the basecoat is formulated to cure in a relatively thick film or layer and be flexible. The Repair Basecoat may have a pot life of about 30 minutes to four hours after mixing. This range of pot life provide a reasonable work time for the repair procedure. Longer or shorter pot life may be used depending on the environment and work schedule. The coating gets thicker as time goes on and becomes very viscous, but still spreadable. This dynamic change of viscosity can be used to good advantage to do the repair. When the viscosity is still low (coating still has thin consistency for about the first 30 minutes), the repair resin can be used to deposit a thin layer onto the damaged areas. The fluid coating will spread into the micro-pits and craters and seal the primed surfaces. As the viscosity increases, the repair resin can be used to build up the coating thickness faster as it has less tendency to flow on its own.

For isolated small pits and craters, brushes with small width or diameter can be used; those with width or diameter less than 4.0 mm are especially preferred. Examples of suitable brushes are the Microbrush and the Ultrabrush, which can be used to deposit the basecoat into the small openings. In contrast to the primer application, the basecoat repair can use heavy, thick deposits. In this case, the Microbrush can deposit a thick layer of basecoat upon one single contact with the substrate without spreading.

On a rotor blade, turbine blade, propeller blade and other fan blades, the thickness of the blade may change along its length, from the inboard section to the outboard section. The blade may also have a twist along the surface. To apply the thick basecoat efficiently in one application, this embodiment discloses the use of a flexible applicator for this purpose. The flexible applicator is bendable along the curvature of the leading edge surface. The size of the flexible applicator can be as big as the area to be repaired. For helicopter rotor blades, the rain erosion damages usually focus around 2 inches (5 cm) on both sides of the leading edge of the blade, while combined sand and rain erosion damages typically occurs within 8 inches (20 cm) on the sides of the leading edge of the blade. Therefore, a flexible applicator with coverage of 8 inches or less on both sides of the rotor blade will be sufficient. Larger size or smaller sizes can be used depending on the actual contour and dimension of the blades.

The flexible applicator can also be used to apply the coating onto the flat surface of the blade. In this case, the edge of the applicator is used like a flat scrapper to smooth out the coating on a flat surface.

The flexible applicator can be made of a semi-rigid, bendable material, which can be metal, plastic, or rubber. It needs to be rigid enough to hold its shape, but flexible enough to bend along a continuously changing curvature. Flexible semi-rigid plastic sheets are preferred. Especially preferred are semi-rigid, flexible plastic sheets with high solvent resistance and good release properties. High density polyethylene and polypropylene sheets are particularly preferred.

It has been found that one of the simpler forms of the flexible applicator is a polyethylene sheet or polypropylene sheet that has the proper combination of being flexible enough to bend along and conform to the curved surface, while still being rigid enough to hold its shape to apply and shape the coating along the curvature. Both high density polyethylene and polypropylene have excellent solvent resistance and release properties. The suitable thickness of the sheet depends on the selection of the applicator materials, as long as it is bendable with proper stiffness. Potential thickness of the applicator may be from 0.005″ to 0.030″ or other suitable thickness as the particular curvature of the substrate and viscosity of the materials being applied dictates. Reasonable experimentation with various thicknesses and types of plastic materials may be necessary to yield optimal results.

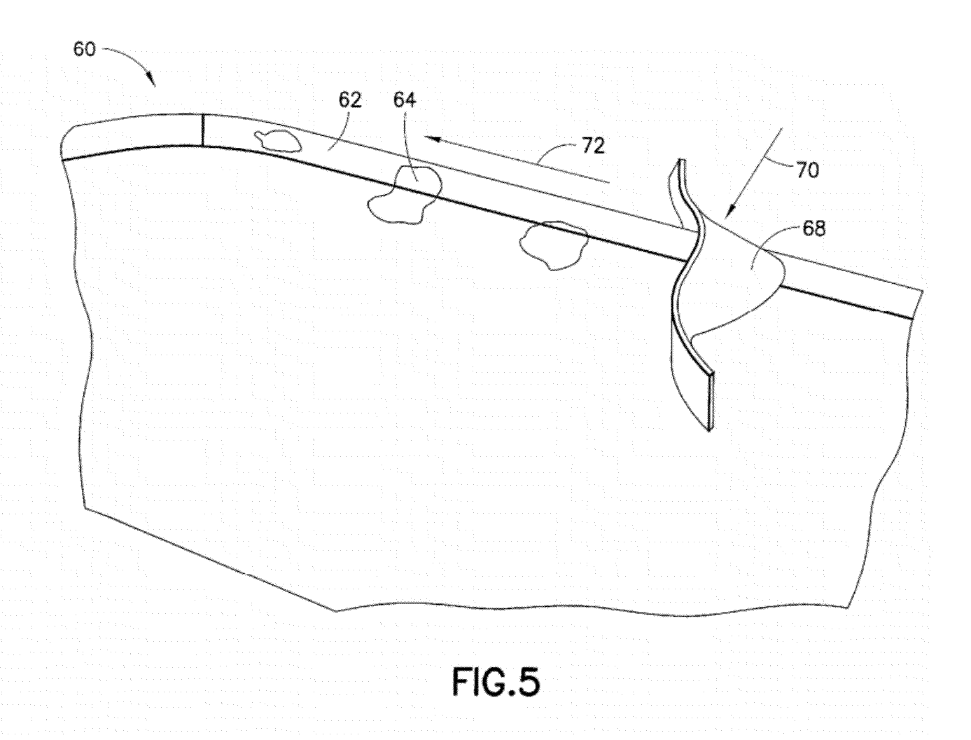

FIG. 5 provides the best visualization of the application technique of this embodiment. The airfoil chosen for illustration is a helicopter rotor blade 60 having a leading edge 62 which has damage cavities 64 in its contoured surfaces. The flexible applicator 68 is made of a 0.010″ (0.25 mm) thick high density polyethylene sheet. The flexible applicator edge 68 forms a continuous line contact with the contoured surface of the leading edge using downward pressure indicated by the force vector arrow 70. At the same time the force 70 is applied in the direction of the surface, the flexible applicator is drawn in a direction 72 that is parallel to the leading edge 62. The basecoat repair material (not visible in this view) is under the curved surface of the flexible applicator in a rolling bank of material that is moved ahead of the flexible applicator edge 68 as the applicator is smoothly drawn in the direction 72. The basecoat repair material completely fills the damage cavities 64 as the rolling bank of repair material passes over the cavities. The applicator edge's continuous line contact with the contoured surface of the leading edge does not deposit significant amounts of repair material anywhere except in the cavities 64.

The dimension of the flexible applicator needs to be wider and longer than the size of the damage cavities. The dimension of the flexible applicator is such that the semi-rigid, semi-flexible applicator is able to maintain the outside contour of the original curved surface, so that it spread the liquid coating to a thickness not thicker than the original outside contour of the airfoil.

This is very important to an aerodynamically sensitive structure like rotor blade, radome, antenna, fan blade, turbine blade, etc.

The repair resin may be applied onto the leading edge surface first, and then the flexible plastic sheet is positioned over the leading edge and pulled along its surface. Or the repair resin may be applied onto the plastic sheet and then it is pulled over the damaged surface area. Or the repair resin may be applied to both the leading edge and the plastic sheet, and then the plastic sheet is pulled along the leading edge to thin out the resin and squeeze the resin into the holes and craters.

### Alternative Flexible Applicator Embodiment

Using the same flexible/conformable scraper blade concept, various hand applicator tools can be designed to fit well with the leading edge structure of various shape and sizes. Such flexible applicators are within the contemplation of this embodiment and various thicknesses, shapes and materials are contemplated as suitable for a flexible applicator so long as they are capable of following the contour of the curved leading edge surfaces. These alternative flexible scrapers are set forth more fully in U.S. patent application Ser. No. 11/818,202, entitled “Method And Coating For Protecting And Repairing An Airfoil Surface Using Molded Boots, Sheet Or Tape” filed on Jun. 23, 2007 which is incorporated by reference in its entirety.

### Handsandable Basecoat and Repair Materials.

For utility as the boot, sheet or tape basecoat material and for use as the basecoat repair material in this invention, the coatings without filler should be elastomeric enough to be erosion resistant to rain or sand. Additional fillers may be added to increase the sand erosion rate. The repair resin/coating may be 100% solid without solvent or it may contain diluents such as solvent or water. The repair resin may be reactive or non-reactive (fully pre-reacted). It may contain some or all of the following ingredients: resins, curing agents, fillers, fibers, fabrics, viscosity modifier, pigments, hydrolysis stabilizers, adhesion promoters, coupling agents, UV stabilizers, defoamers, wetting agents, etc. The repair resin/coating may be as fluid as a brushable coating up to as viscous as a flowable caulking compound.

For use as sandable, erosion resistant coating, the coating is made from a highly flexible coating composition with additional fillers added at a sufficient level to allow for particulate removal of the top surface of the polymer during sanding. The organic polymers suitable for forming the hand sandable coatings can comprise polyacetals, polyureas, polyurethanes, polyolefins, polyacrylics, polycarbonates, polyalkyds, polystyrenes, polyesters, polyamides, polyaramides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyolefins, polysiloxanes, fluoropolymers, polybutadienes, polyisoprenes, urethane acrylates, urethane methacrylates, natural rubber, nitrile rubber, or other synthetic polymers or co-polymers, polyblends that exhibit high flexibility or elastomeric properties, or a combination comprising at least one of the foregoing organic polymers. Exemplary organic polymers are polyurethanes, polyureas, fluoropolymers, urethane acrylates/methacrylates, fluorinated urethanes, fluorinated polyurea, copolymer or polyblends of polyurethane, polyurea or fluoropolymers. It is desirable for the polyurethane, the polyurea, and the fluoropolymers, to be an elastomer. The aforementioned organic polymers listed above can be blended and/or copolymerized with the polyurethane or polyurea if desired. The base elastomers can be fully reacted such as water based polyurethane, fully reacted thermoplastic elastomers such as polyurethane, TPR (Thermoplastic rubber), EPDM rubber, nitrile rubber, chlorinated rubber, butyl rubber, SBR (styrene butadiene) rubber, fluoroelastomer, silicone rubber, natural rubber, etc. The most preferred elastomer is polyurethane, polyurea and fluoroelastomers. Polyurethane and polyurea are both sometimes referred as polyurethane commercially. In this application, urethane copolymers, urea copolymers are also regarded as polyurethanes.

The isocyanates in the polyurethane elastomers can be aromatic or aliphatic. Useful aromatic diisocyanates can include, for example, 2,4-toluene diisocyanate and 2,6-toluene diisocyanate (each generally referred to as TDI); mixtures of the two TDI isomers; 4,4′-diisocyanatodiphenylmethane (MDI); p-phenylene diisocyanate (PPDI); diphenyl-4,4′-diisocyanate; dibenzyl-4,4′-diisocyanate; stilbene-4,4′-diisocyanate; benzophenone-4,4′-diisocyanate; 1,3- and 1,4-xylene diisocyanates; or the like, or a combination comprising at least one of the foregoing aromatic isocyanates.

Useful aliphatic diisocyanates can include, for example, 1,6-hexamethylene diisocyanate (HDI); 1,3-cyclohexyl diisocyanate; 1,4-cyclohexyl diisocyanate (CHDI); the saturated diphenylmethane diisocyanate known as H(12)MDI; isophorone diisocyanate (IPDI); or the like; or a combination comprising at least one of the foregoing isocyanates.

Other exemplary polyisocyanates include hexamethylene diisocyanate (HDI), 2,2,4- and/or 2,4,4-trimethyl-1,6-hexamethylene diisocyanate, dodecamethylene diisocyanate, 1,4-diisocyanatocyclohexane, 1-isocyanato-3,3,5-trimethyl-5-isocyanatomethylcyclohexane (IPDI), 2,4′- and/or 4,4′-diisocyanato-dicyclohexyl methane, 2,4- and/or 4,4′-diisocyanato-diphenyl methane and mixtures of these isomers with their higher homologues which are obtained by the phosgenation of aniline/formaldehyde condensates, 2,4- and/or 2,6-diisocyanatotoluene and any mixtures of these compounds.

In one embodiment, derivatives of these monomeric polyisocyanates can be used. These derivatives include polyisocyanates containing biuret groups as described, for example, in U.S. Pat. No. 3,124,605, U.S. Pat. No. 3,201,372 and DE-OS 1,101,394; polyisocyanates containing isocyanurate groups as described, for example, in U.S. Pat. No. 3,001,973, DE-PS 1,022,789, 1,222,067 and 1,027,394 and DE-OS 1,929,034 and 2,004,048; polyisocyanates containing urethane groups as described, for example, in DE-OS 953,012, BE-PS 752,261 and U.S. Pat. Nos. 3,394,164 and 3,644,457; polyisocyanates containing carbodiimide groups as described in DE-PS 1,092,007, U.S. Pat. No. 3,152,162 and DE-OS 2,504,400, 2,537,685 and 2,552,350; and polyisocyanates containing allophanate groups as described, for example, in GB-PS 994,890, BE-PS 761,626 and NL-OS 7,102,524. In another embodiment, N,N′,N″-tris-(6-isocyanatohexyl)-biuret and mixtures thereof with its higher homologues and N,N′,N″-tris-(6-isocyanatohexyl)-isocyanurate and mixtures thereof with its higher homologues containing more than one isocyanurate ring can be used.

Examples of suitable polyols are polyester polyols, polycaprolactone polyols, polyether polyols, polyhydroxy polycarbonates, polyhydroxy polyacetals, polyhydroxy polyacrylates, polyhydroxy polyester amides and polyhydroxy polythioethers. Exemplary polyols are polyester polyols, polyether polyols, polyesters derived from lactones (e.g., ε-caprolactone or ω-hydroxycaproic acid), or a combination comprising at least one of the foregoing polyols.

Exemplary isocyanate prepolymers are TDI-ether, TDI-ester, TDI-lactone, MDI-ether, MDI-ester, H12MDI-ether, H12MDI-ester and similar prepolymers made from HDI, IPDI and PPDI. The isocyanate prepolymers with low free isocyanate monomers are preferred.

The coating composition also comprises an optional curing agent. Examples of suitable curing agents are aromatic amines that can be used as curing agents are phenylene diamine, 4,4′methylene-bis-(2-chloroaniline), 4,4′methylenedianiline (MDA), 4,4′methylenebis(2,6-diethylaniline), 4,4′methylenebis(2,6-dimethylaniline), 4,4′methylenebis(2-isopropyl-6-methylaniline), 4,4′methylenebis(2-ethyl-6-methylaniline), 4,4′methylenebis(2,6-isopropylaniline), 4,4′methylenebis(3-chloro-2,6-diethylaniline) (MCDEA), 1,3-propanediolbis(4-aminobenzoate), diethyltoluenediamine (DETDA), dimethylthiotoluenediamine; or the like; or a combination comprising at least one of the foregoing aromatic amines. Polyaspartic esters may be used. Polyol curatives are polyester polyols, polycaprolactone polyols, polyether polyols, polyhydroxy polycarbonates, polyhydroxy polyacetals, polyhydroxy polyacrylates, polyhydroxy polyester amides and polyhydroxy polythioethers. Exemplary polyols are polyester polyols, polyether polyols, polyesters derived from lactones (e.g., ε-caprolactone or ω-hydroxycaproic acid), or a combination comprising at least one of the foregoing polyols. Imines are useful curatives, including aldimines, ketimines, and multifunctional imines. In addition to the above, curing agents that can produce elastomeric polymers with the isocyanate-terminated prepolymers or polyisocyanates are suitable. Additional examples of other suitable curing agents are listed in patent application Ser. No. 11/136,827, filed May 24, 2005, which is incorporated herein by reference.

Atmospheric moisture may serve to cure solely or may catalyze the reaction between the polyurethane and the curing agent. This is referred to as moisture cure. For aqueous coatings, polyurethane dispersions can be used with or without curing agents. The crosslinking of aqueous polyurethane dispersions may be accomplished by the use of isocyanates, epoxy, aziridines, carbodiimides, and other functional materials.

Other additives useful in the coating compositions include leveling agents, adhesion promoters, coupling agents, defoamers, hydrolysis stabilizers, UV stabilizers, pigments, dispersants, curing accelerators, diluents, or combinations thereof.

In order to exhibit high erosion resistance with the fillers, the basecoat preferably utilizes a coating composition in which the elastomeric base of the repair coating prior to the addition of any fillers has been determined to preferably have a minimum tensile strength of 1000 psi, an elongation at break of higher than 100%, and a Shore A hardness of less than 95 A, more preferred is 200% elongation and most preferred 350% elongation. These properties are generally tested according to ASTM D412-92 or D2370 if a film coating is being tested. Exemplary elastomeric bases along with specialized testing and test methods are as disclosed in U.S. patent application Ser. No. 11/136,827, filed May 24, 2005, which is incorporated herein by reference in its entirety.

The fillers that may be used to render the elastomeric base hand-sandable and will also increase the sand erosion rate for the repair basecoat layer include, but are not limited to, the following list:

Silicates (such as talc, clays, (montmorillonite) feldspar, mica, calcium silicate, calcium metasilicate, sodium aluminosilicate, sodium silicate), metal sulfates (such as calcium sulfate, barium sulfate, sodium sulfate, aluminum sodium sulfate, aluminum sulfate), gypsum, aluminum trihydrate, metal oxides (such as calcium oxide (lime), aluminum oxide, titanium dioxide, iron oxide, tin oxide) and metal sulfites, metal powders, metal flakes, metal fibers, milled metal fibers, metal nitrides, graphite, carbon nanotubes, carbon fibers and milled carbon fibers, silica (such as quartz, glass beads, glass bubbles and glass fibers), metal-coated glass spheres, metal-coated hollow spheres, buckyballs, electroactive polymers, antimony-doped tin oxide, carbon blacks, coke, micro-balloons, and oxides, borides, carbides, nitrides and silicates from the group of compounds containing boron, aluminum, silicon, titanium, tungsten, and zirconium compounds.

Examples of organic based fillers can be used include thermoplastic powdery material such as polycarbonate, polyetherimide, polyester, polyethylene, polysulfone, polystyrene, acrylonitrile-butadiene-styrene block copolymer, Teflon, fluoropolymers, polypropylene, acetal polymers, polyvinyl chloride, polyurethanes, polyureas, nylon and combinations thereof. In general, some useful thermoplastic polymers are those having a high melting temperature or good heat resistance properties. There are several ways to form a thermoplastic abrasive particle known in the art.

The useful fillers have a hardness greater than that of the material forming the continuous phase of the coating. The particle size of the fillers may be from nano-sized to 200 microns, or preferably less than 100 microns. The filler content in the hand sandable coating, based on the total solid weight, can range from 10% by weight to 90%, depending on the interaction of the fillers and the base elastomers. Preferred is 20% to 80% by weight and more preferred is 30% to 70% by weight.

The surface gloss of the basecoat may be gloss, semi-gloss or matte. In some applications, the repair basecoat may be used without additional topcoat. For those applications that require a different surface gloss or different functional surface properties, another topcoat layer may be applied. The topcoat may be used to change the surface gloss, surface texture, or surface properties, such as antistatic or electrical conductivity. As earlier described, the topcoat may also be formulated to provide higher erosion (sand and water) resistance and applied over a basecoat. In the preferred embodiment, the sandable erosion resistant basecoat layer constitutes at least 50% of the total coating thickness. The total thickness of the hand sandable erosion protection system can be any thickness suitable for the protection of the substrate. In general, suitable erosion protection of a typical substrate involves a minimum thickness of 0.006″, more preferably 0.008″, most preferably more than 0.012″. A typical thickness for radome protection is 0.014″. A typical thickness for rotor blade protection is about 0.020″ or higher. If preformed boot or sheet or tape is used, the thickness can be higher than 0.060″ or even higher than 0.100″.

If the coating is 100% solid, one application with this procedure will fill in the cavities of the damage sites to their full height. If the coating contains solvent, the dry coating thickness depends on the dry solid content of the coating. In this case, a second application may be applied to build up the dry film thickness at the damage sites. Even though the evaporation of the solvent left very slight indentations at the damage sites, one application of the basecoat with the unique flexible applicator was able to repair the rotor blade quickly and the helicopter was able to continue flying in a short time period with no detrimental aerodynamic effects on the rotor blade.

The basecoat described here is used to fill in the erosion and impact damage sites and cavities.

We have found a very efficient method to repair the deep craters, pits and holes formed by erosion and impact damages. First, the repair resin is formulated so that there is a somewhat greater degree of “body” to it at the time of repair. The repair resin can be thixotropic, shear thinning, or simply having at least moderate viscosity. “Moderate viscosity” means that the repair resin can be brush applied and does not flow away from the applied surface. The repair resin can preferably be reactive, in which case the viscosity increases with time after the components are mixed together. The repair resin can also be nonreactive, being a fully reacted resin dissolved in solvent or water.

In practicing this invention, the repair resin/coating may contain special effect fillers, additives, fibers, fabrics to provide special functions and properties. If the added filler reduces the erosion resistance of the resin/coating, another layer of the topcoat with higher sand or rain erosion resistance can be applied on top of the repair resin/coating. In this case, the repair procedure comprises the application of primer (optional), the basecoat and the topcoat. The topcoat may be formulated to provide the desired color, gloss and erosion resistance, but in general not hand sandable, by the definition of this invention. The invention may also be applied to single or multi-layered coating systems.

In some special applications, the topcoat may need to contain higher additive and/or filler loading in order to exhibit special properties such as antistatic properties. Alternatively, the topcoat may contain fillers that make the topcoat hand sandable. Even for these applications, it is still desirable to have the basecoat with hand sanding properties. These embodiments are considered to be within the scope of this invention.

### Hand Sandable Elastomers Testing Techniques

One method to determine whether a coating is hand sandable is to use a hand sanding test. Another method is to use a mechanical particulate erosion test or a Taber Abrasion apparatus and then correlate to the ease of the hand sanding.

### Hand Sanding Test

The coating materials are either spray coated onto the substrate or glued to the substrate with a double faced permanent pressure sensitive adhesive. A 3″ diameter sanding disc, 3M Roloc TSM 361F, with 80 grit aluminum oxide abrasive, is to be used as the sanding medium. The disc is stiff with metal hub at the center. The disc is bent on both side with fingers, and the middle section is pressed down against the elastomeric coating surface by using two central fingers. Using moderately firm pressure, the sanding is done with a timer clock for one minute. The sanding was focused in a small area about 1.5″×3″ in dimension. The weights before and after the hand sanding were recorded.

### Comparative Example 1

Caapcoat Black B-274, a sprayable rain erosion resistant coating manufactured by Caap, Inc. was sanded as in the above procedure. The coating felt gummy, with a lot of resistance to sanding. The sanding disc got hot after about 15 seconds of hand sanding. Only trace amount of sanding powder/debris was obtained. The arm used in the hand sanding felt sore and tired after 40 seconds. The weight loss after one minute of sanding was 0.029 gram.

### Comparative Example 2

Caapcoat FP-200, a gray sprayable rain erosion resistant basecoat used in a basecoat-topcoat FP-250 coating system, was hand sanded. The coating felt gummy, with a lot of friction. The hand got tired after about 40 seconds. Low sanding dust was observed. There was some heat built up around 30 seconds. The weight loss after one minute was 0.040 grams.

### Comparative Example 3

Caapcoat White, a gloss white sprayable rain erosion resistant coating, was sanded. Results were similar to Comparative Example 2. The weight loss after one minute was 0.022 grams.

### Comparative Example 4

Caapcoat Fluoroelastomer V, a gray sprayable elastomeric rain erosion coating, was sanded. The film used for the sand test was 0.002″ thick due to the low solid content of the coating. The coating was sanded. The film ripped through easily due to low film thickness. However, poor sandability with very low sanding dust was observed. The weight loss after one minute, including the ripped pieces, was 0.050 grams.

### Comparative Example 5

Chemglaze M331, a gloss black sprayable rain erosion resistant coating manufactured by Lord Corporation, was sanded. The coating produced very low sanding dust after one minute. The hands get tired after about 50 seconds. The weight loss was 0.024 grams after one minute.

### Comparative Example 6

A piece cut from a Task L-101 molded boot manufactured by Task Inc. was sanded. The sanding disc got very hot in about 7 seconds. The sanding had to be continued by switching fingers to be comfortable. The weight loss was 0.062 grams after one minute.

### Comparative Example 7

3M 8545 tape, a black molded erosion resistant polyurethane sheet manufactured by 3M Company, was sanded. The sanding disc got very hot in 15 seconds. The material felt gummy, with trace of sanding dust rolled up together in lumpy form. The weight loss was 0.028 grams after one minute.

### Comparative Example 8

3M 8667 tape, a black molded erosion resistant polyurethane tape with pressure sensitive adhesive backing, was sanded. There was a lot of friction. The sanding disc got very hot in 15 seconds. The trace sanding dust rolled up into small lumps. The weight loss was 0.018 grams after one minute.

As seen in the above Comparative Examples, a person trying to sand a small 1.5″×3″ area for one minute using the current commercial erosion resistant coating could not remove much material, at the same time, the person felt tired, exhausted and also encountered uncomfortable heat generated in very short period of hand sanding. Thus when trying to utilize the materials of the Comparative Examples 1-8, it would not be practical or even possible to conduct a field repair of a rotor blade, which may measure about 20 feet long.

The hand sanding properties are determined by the total filler loading. As the filler loading increases, the polymeric film on top of the elastomer can be broken away and form loose debris, thereby making the hand sanding easier to perform. Because each filler has its own density and surface properties, the interaction of filler and the base elastomer varies and can be determined by experimental trials.

In contrast with the above Comparative Examples, a good hand sandable coating produced loose debris in powder form, with substantial amount of debris left on the coating surface after sanding, instead of being trapped inside the abrasive particles on the sand paper. In similar procedure by the same person using the same technique, the weight loss of the hand sandable coating is higher than 0.080 gram, preferably higher than 0.100 grams, and even more preferably higher than 0.150 grams.

FIG. 9 illustrates Example of the mechanical sand erosion apparatus as practiced in the Particle Erosion Test Apparatus, operated by the University of Dayton Research Institute, Dayton, Ohio. In this test, particles 90 are accelerated in a small diameter (approximately 0.25-inch) high-speed gas jet 92 and directed onto a test specimen 94 as illustrated in FIG. 9. Since the diameter of the jet is smaller than the test specimen area, the specimen holder and jet are articulated so that the test specimen 96 is moved through the jet in a uniform manner. This articulation provides a uniform particle loading (particle mass intercepted per unit surface area) over square area of approximately 316 cm2 (i.e., 7.0-inch square). The inner 6 inch square is considered valid test area. For the sand erosion test using a flat 1″×1″ specimen, the net sand erosion exposure area is a circle of 2.0 centimeter.

Compressed air 98 provides the transport gas stream with regulators and pressure transducers to measure and control the pressure at the nozzle inlet. Particles are metered into the transport gas stream from a pressurized screw feeder system. Since the screw feeder provides a very accurate and uniform particle flow, the particle mass applied to the specimen is determined by the run time based on prior calibration of the screw feeder.

Velocity is determined as a function of the nozzle inlet pressure by prior calibration. Thus, for a given test, a specific test velocity can be selected from this velocity versus pressure calibration. Particle size, velocity and impact angle 97 can be controlled independently. This provides an excellent capability to parametrically evaluate the response of critical materials and coatings to solid particle impact effects. Materials from such components as rotorcraft blade coatings, leading edges, windscreens, radomes, paints, and any special coatings can be evaluated in a well-controlled laboratory environment under realistic particle impact conditions.

The Particle Erosion Test Facility differs from the real flight environment in that the specimen is stationary and the particle field is moving at the specified impact velocity. Whereas the key parameters in the flight environment are the static cloud mass concentration (mass or volume of particles per unit volume) and velocity, in the particle erosion facility the key parameters are the particle mass loading and velocity. The relationship between the mass loading in the test facility, and dust cloud concentration, impact velocity and time in the flight environment is as follows:

Mass Load=Concentration*speed*time(*unit conversion factors).

Specimen size of 1 inch square is used to determine the sand erosion rate. The sand erosion was conducted with dry silica sand that have been sieved to 177-250 microns (um), Sand is sieved from F-series unground silica from U.S. Silica at a mean particle stream velocity of 353 miles per hour, using an impact angle of 30 degrees. The mass of impinging particles is set at 10 grams per square centimeter.

In the testing, the sand erosion rate for the same material from various test runs will cover a range of values. In general, sand erosion rates less than 0.020 grams is difficult to sand by hand. Values above 0.040 grams are easier to sand. Values between 0.020 and 0.035 grams are transitional range. When the filler loading is very high, the weight loss range for the same materials during different runs may be have a larger variation of test values. However, as long as they are above 0.050 grams, they will be easily hand sandable within the scope of this invention.

In practicing this invention in sandy environments, a layer of high sand erosion resistance elastomer is used on top of the sandable basecoat layer. To maintain the sandability, it is preferred to let the sandable basecoat occupy at least 50% of the total coating thickness. In general, it is preferred to use 0.008″ or thinner, more preferably 0.004″ or thinner layer of the topcoat. In this embodiment, the sand erosion will erode the top layer, and then the basecoat and primer. When the basecoat is exposed, the erosion damage is first covered with a renewable sand erosion resistant coating. When the basecoat is eroded, it is easily sanded down and repaired with the procedure disclosed in this invention.

In one embodiment, the basecoat is configured to have a sand erosion rate (mass weight loss) of greater than 0.024 grams when tested according to the Particle Erosion Test Apparatus under 353 mph, 30 degree impact angle, 1″×1″ specimen size, with 177-250 micron sand particles, more preferably greater than 0.030 grams, It is even more preferred to have the basecoat configured to have sand erosion rate of higher than 0.040 grams for better hand sandability.

In another embodiment, the preformed boot, sheet, or tape (basecoat) is configured to have a sand erosion rate (mass weight loss) of greater than 0.024 grams, and at the same time contains a topcoat layer of having a sand erosion rate of less than 0.024, preferably less than 0.020 grams. It is more preferred to have a basecoat layer with sand erosion rate of higher than 0.040 grams, and a topcoat layer with a sand erosion rate of less than 0.015 grams, more preferably less than 0.010 grams. It is even more preferred to have a basecoat with sand erosion rate of greater than 0.050 grams and topcoat sand erosion rate of less than 0.010 grams. In most combinations, it is in general most preferred to have a topcoat with sand erosion rate of less than 0.010 grams.

In another embodiment, the basecoat is configured to have a sand erosion rate of greater than 0.040 grams, and a topcoat with sand erosion rate of lower than 0.040 grams. In another embodiment, the basecoat is configured to have a sand erosion rate of greater than 0.050 grams, and a topcoat with sand erosion rate of lower than 0.040 grams.

In another embodiment, the basecoat is configured to have a sand erosion rate of greater than 0.050 grams, and a topcoat with sand erosion rate of lower than 0.050 grams, preferably less than 0.040 grams, more preferably less than 0.020 grams, most preferably less than 0.010 grams. Similar arrangement can be made to pair basecoat and topcoat up, with basecoat having higher sand erosion rates than the topcoat.

For use in the water environment without sand erosion concerns, the basecoat layer containing filler that retains good rain erosion resistance can be used alone, forming a single layer sandable rain erosion protection coating system. In addition, a sandable topcoat layer may be added on top of the sandable basecoat layer. In this case, both layers are hand sandable. The requirements in this case are that both the basecoat and topcoat should have good rain erosion properties.

In the above embodiments, the hand sandable basecoat may be supplied as preformed boot, sheet or tape. In these cases, an adhesive with or without gap controlling open mesh or fabric may be used to bond the boot or sheet to the substrate. The hand sandable boot or sheet may be used as is without topcoat if it is in water environment and it has good water erosion resistance. In general, it is preferred to provide the hand sandable boot or sheet with another layer of topcoat with lower sand erosion rate than boot or sheet possess. The topcoat may be brushed on, sprayed on, or laminated on as a second layer on top of the boot or sheet.

### Application of the Repair Topcoat

For minor damage situations where the erosion has only removed the topcoat and exposed the underlying basecoat, these areas need only topcoat repair. In addition, pits and craters smaller than 1/16″ can also be repaired by repairing the topcoat only. Slightly damaged surfaces can be wiped clean with solvents such as xylene, toluene, butyl acetate, MEK (methyl ethyl ketone), or MIL-PRF-680B solvents, mineral spirits, VM&P naphtha, acetone, and other solvents.

Repair Kit with Precision Water Addition for Control of Moisture Cure Rate

In one embodiment of the repair kit, an additional component of the kit is a syringe or other means suitable for adding very small amounts of water to the repair basecoat or repair topcoat compositions are also included in the kits. Typically it may be desirable to add less than 2.0% of water based on the total weight of the repair basecoat or repair topcoat composition to enhance the rate of cure. Since the preferred polyurea or polyurethane systems cure via moisture curing, it is important to be able to accurately control the amount of water present to control the rate of moisture curing that takes place. Further, the repair kits may be used in repair locations which vary from a very low atmospheric moisture environment, like desert conditions to a very high atmospheric moisture environment like tropical rain forest conditions. Preferably, the small amount of water can be dissolved in a solvent carrier and packaged into a syringe or similar delivery device. Having the ability to add water as an optional separate component and adding only as much as needed makes it easier to control the rate of curing of the topcoat and basecoat components. Since pot life shortens with increasing levels of moisture, it is a delicate balance that must be maintained. These precision delivery systems like micro syringes are advantageous. The kits containing this water delivery device will be easier to control in humid and dry climates. This ability to optionally add specific amounts of water to the multipart reactive polyurea or polyurethane systems, especially those with aldimine and ketamine curing agents, are especially desirable. Other chemistries that can be influenced by the presence of moisture can also benefit.

### Early Erosion Warning System-Three Color Repair Kit Embodiment

This improved repair kit embodiment discloses the use of contrasting color in forming and repairing the airfoil erosion protection system. The coating system may comprise a primer and/or adhesive of color A, a basecoat of color B, and an optional topcoat of color C. The colors of A, B, and C are formulated to provide a color contrast so that when the erosion reaches at each layer, it provides a visual warning and indication of the need for repair. The use of primer is optional, as some basecoat resin systems may possess sufficient adhesion that no primer is needed. In some cases, the coating system may contain only primer and basecoat, or in others only basecoat and topcoat.

In one embodiment, the basecoat is formulated to be in grayish color to provide contrast to the matte black topcoat. This serves as an Early Warning Indicator for erosion damage. The service life the rotor and its elastomeric protective coating can be greatly increased if routine repair procedures incorporate regular inspection for any visual indication of damage and if any is found, four to six repair layers of matte topcoat are sprayed whenever the gray basecoat is exposed to prevent any further erosion of the basecoat. The matte black topcoat is designed for use as a regular maintenance touch-up coating. It is to be used whenever the gray basecoat becomes visible.

In one embodiment, the hand sandable basecoat is supplied as preformed boot or sheet in one color. An adhesive of a second color, with or without gap controlling open mesh or fabric, is used to bond the boot or sheet to the substrate. Then a topcoat of a third color is used on top of the boot or sheet. This forms the Early Erosion Warning System for the boot or sheet erosion protection system. This design can be used on new airfoils or used as repair system in the field.

In routine use, a repair sprayable or brushable topcoat is applied whenever the topcoat is eroded away and the gray basecoat is shown. The topcoat is sprayed on or brushed on while the rotor blade is still on the aircraft, in the field. According to the repair method embodiment, the application of the topcoat is used as the first line of defense against erosion damage.

The topcoat may be applied by brushing, rolling, dipping or spraying. If an underlying repair basecoat has been applied, the heavy thickness of the basecoat makes it preferred to allow time for the solvent to flash off from the basecoat before the topcoat is applied. Depending on application environment, one to two hours waiting time is generally sufficient. To obtain the best matte appearance, spraying is the preferred application method.

Spraying of the coating can be accomplished by any of the known spraying methods, including, but not limited to trigger sprayer, air powered pressure sprayer, propellant-powered sprayer, aerosol sprayer, pump sprayer, etc. For field repairs away from a pressurized air supply source, a small disposable hand trigger sprayer or aerosol propellant powered sprayer is especially preferred. Example of suitable propellant powered sprayer is the Preval Paint Sprayer (Spray Gun). The Preval Paint Sprayer includes a propellant-filled power unit for the sprayer and a container for the paint.

Typically a single spraying pass of the matte topcoat deposit about 0.0005″ (0.5 mils) of dried topcoat. Although it may vary with severity of damage it has been found that 4-6 spraying layers (0.002-0.003″) are suitable to maintain the erosion resistance of the coated blades after repair. The topcoat can be sprayed as many coats as needed. Alternatively, the topcoat may be brushed on top of the basecoat. To maximize the sand erosion resistance, a topcoat with low filler content, high sand erosion resistance is preferred. After repair, a rotor blade with renewed erosion resistance is placed back to service.

The repair topcoat may also be applied by brushes, paint rollers and specialty applicators like those manufactured by Designetics, Holland, Ohio. The construction of the applicator may be made of felt, bristles, natural and synthetic fibers and filaments, foam,

### Example of Erosion Protection Using Hand Sandable Preformed Boot, Sheet or Tape

In the following embodiments, a releasable tooling surface, treated with release agent, or lined with release film or sheet, is used to form the preformed boots or sheets for later bonding onto suitable airfoil substrates. The tooling surface may be a flat surface or a curved surface complementary to the shape of the desired airfoil substrate. The surface may be smooth, glossy, matte, or textured. The tooling flat surface is typically used to form a sheet or tape. A curved surface is used to form a boot. When the flat surface is matte, the resulting sheet or tape can adopt the appearance of a matter surface without the use of a matting agent. The primer, adhesive, boot, sheet, tape and topcoat each has its own color to form the early erosion warning system.

In one embodiment, a hand sandable sprayable coating is sprayed onto a tooling surface. After drying and curing at ambient temperature to the desired thickness, the dry coating forms a flat sheet or an airfoil shaped boot. Then sheet or boot is bonded to the actual airfoil substrate using suitable adhesive with or without another primer. An additional sprayable topcoat is sprayed on top of the sheet or boot to the desired thickness. The topcoat may be hand sandable or sand erosion resistant. It is in general preferred to have the topcoat more sand erosion resistant than the basecoat. This forms a field repairable erosion protection system with preformed boot or sheet or tape.

In still another embodiment, the process of the above embodiment is repeated except that an additional topcoat is applied on the basecoat of the preformed sheet, tape or boot. After curing of the basecoat-topcoat combination, the sheet, tape or boot is removed and bonded onto the desired substrate.

In another embodiment, the primer is first sprayed onto the releasable tooling surface. After the curing of the primer, multiple basecoat layers are sprayed to reach the desired thickness. After the flash off and partial curing of the basecoat, multiple layers of the topcoat are sprayed on top of the basecoat.

This formed the three-layered, spray-applied article that can be regarded as preformed boot, sheet or tape. Tapered thickness profiles or uniform thickness profiles may be formed with this method. The three layered article may be removed from the tooling surface and be used to protect the substrate against erosion damages.

In yet another embodiment, the spraying process is replaced by dipping or curtain coating, slot die coating, calendaring, extrusion or other coating process to form the sheet, tape, or boot. Other processes that are suitable to form the polymer sheet or boot into a predetermined shape also may be used.

In another embodiment, the sprayable coating is replaced by a hand sandable molding resin. The tooling surface is replaced by an open mold or closed mold. A topcoat is first formed on the mold surface to form the topcoat; then a hand sandable molding resin is applied onto the topcoat previously deposited on the mold surface. The molding process may be cast molding, compression molding, resin transfer molding, blow molding or other suitable molding process. Extrusion processes may also be used for linear configurations. Certainly the preforming of tapes and sheets for these embodiments are readily adapted to be made by extrusion processes.

In another embodiment, the molded hand sandable boot or sheet is further sprayed with another topcoat after removal from the molding process; said topcoat is preferably of higher sand erosion resistance. The topcoated boot is then used in the field and bonded to an airfoil substrate, using adhesive with or without open mesh gap control material and an optional primer to form the bond.

If there are no sand erosion concerns in the working environment of the airfoil and the hand sandable preformed boot has good rain erosion resistance, the preformed boot can be used without another layer of topcoat. If there is sand erosion or other need to change the outer appearance or surface properties, another topcoat may be sprayed on by the end user. The topcoat will have its special functional properties.

### Embodiments of Repair Kits

The Repair kit disclosed in this patent application is designed to renew the sand and rain erosion topcoat damage on an airfoil article coated with a two layered or three-layered elastomeric coating system. The three layers may contain a green primer, a gray basecoat and a black topcoat. Other color combinations can be used as long as they are contrasting colors to provide visual detection of the damage to each layer. The kit is especially suitable for repairing early erosion damages that involves topcoat damage and small basecoat and primer damages.

The kit preferably contains a special sanding screen with open mesh that can trap and remove the topcoat debris. It more preferably also contains special precut sanding paper that can be conveniently used by hand to remove minor amount of topcoat without severe damage to the basecoat.

The repair kit of this invention may contain some or all of the following listed items or additional items:

Repair Topcoat, two or three parts system.

Paint Sprayer

Syringe with water or water/solvent solution for addition into the Repair Topcoat during mixing.

Anti-fog Safety Goggle

Gloves

Disposable (Preval) Spray Gun with 6 oz plastic bottle

Sanding screen, various grit sizes, 80 grits, 100 grits, 150 grots, 180 grits, 220 grits, grits, or finer. precut to 4.5″×5.5″ or other sizes

Sanding sponges of 100 grit and other grit sizes,

Sanding blocks, Sanding paper, 80 grits, 100 grits, 120 grits, or finer. high flexibility, precut to 3″×4.5″ or other sizes

Lint free clean wipes

Can Opener for opening container

Cleaning solvent for coated blades

An optional repair primer may be included, but may not be needed for small holes at the early stage of repair. The above kit is especially suited for repairing the early stage of rain and sand erosion damages. It is noted that the container size, content size, individual component size and grade may be changed to fit the end use conditions. Additional items can be added to the above items, such as various grades of sanding supplies.

### Example 12

### Method of Using the Kit

The sanding screen and sand paper may be used with bare hands or with gloves. Bare hands may have better control on the movement of the sanding screen and the small width sand paper. Disposable gloves are needed to handle the repair chemicals. Respirator is needed when spraying the repair topcoat.

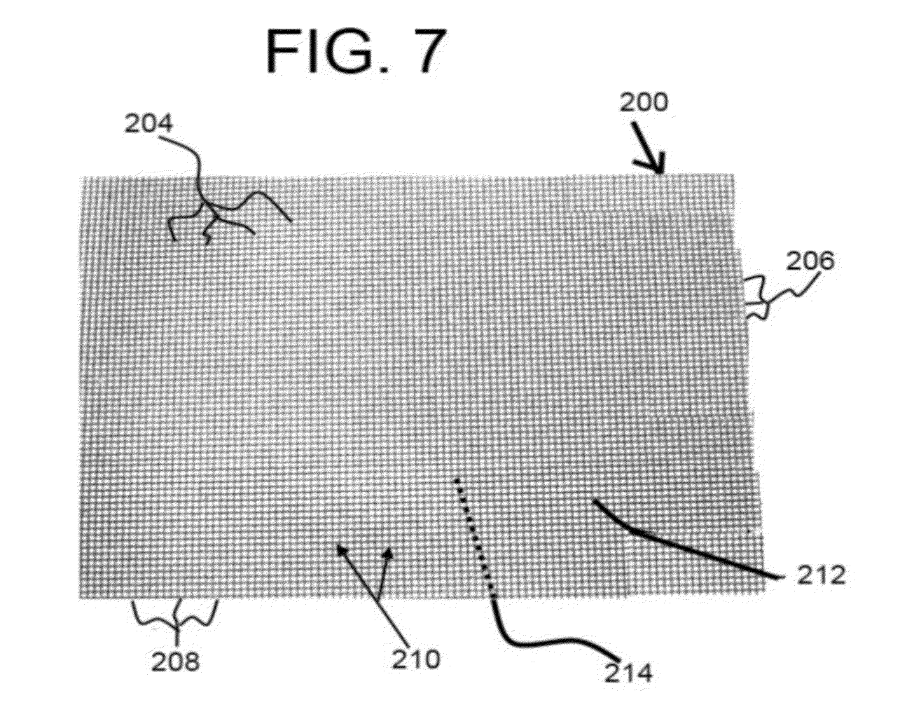

Use of Sanding Screens: FIG. 7 illustrates the special grade of the sanding screen 200 which is selected to be effective to trap the topcoat debris without severe damage to the exposed hand sandable basecoat. It is preferably cut to a size which makes it easy to manipulate using the fingers, so the illustrated piece is only about 4 to 6 inches in total length. The size can be any size as long as it can fit the working surface or working hands comfortably. A good size is to fit the size of the hand so that it can be bent over the nose of the leading edge.

It is preferred that the sanding screen have a 3-dimensional open structure with interstices 204 between the array of perpendicular filaments 206, 208. The screens have abrasive grit 210 imbedded on the filaments 206, 208 on both planar sides 212, 214. This allows both sides of the screen to be selected for the suitable tasks. It has been found through experimentation that 180 or 220 grit sanding screens are especially preferred for early stage of topcoat repair. Later 60 to 150 grits sanding screen may be used when more abrasive power is needed. The objective is to smooth out all imperfections or damages in the leading edge with the sanding screen. If the sanding screen clogs, it can be flipped to use the other side, or shaken to loosen the trapped powders. If the screen still clogs with debris, then a new screen can be used. Sanded coating powders are heavy and typically fall to the ground. If dusty powder is observed, dust mask can be used to avoid inhaling the sanding dust. When it is important not to damage the hand sandable basecoat, it is preferred to have non-abrasive open structure to remove the topcoat debris. The grit size can be controlled with 100 grit or finer. It is especially to control the grit size to 180 grits or finer, such as 220 grits. The 3-dimensional open structure may be made of fiber, fiberglass, fabric, paper, non-woven, etc.

### Use of Precut Sand Paper,

After removal of the topcoat debris, there may be a 0.002″ to 0.004″ thick topcoat along the exposed basecoat boundary line. Sanding screen may be used to smooth out the line, but a precut fine grit sand paper, for example 120 to 220 grit sand paper can be used to thin down the topcoat and smooth out the boundary line. A 150-180 grit sand paper is especially preferred because it removes the damaged topcoat without causing excessive basecoat removal. The sand paper is cut to 3″×4.5″ size or other sizes, which can be advantageously used in two ways, either with gloves or bare hands. Other suitable sizes to hold in hand can be used. It is preferred to use a width that can be bent to fit between the fingers. The human finger has been found to be an excellent tool, having a sensitive touch with a good feel for smoothing down the leading edge area. It is desired to have at least the minimum coating thickness of topcoat to be effective in erosion protection. Sanding off too much coating at the leading edge nose is not desirable.

The most precise way to use this sand paper is to use bare fingers to bend the 3″ wide sand paper around the two fingers, as shown in the photos below. The photos show a newly coated leading edge. In actual use, the coated airfoil will have pre-existing coating damages. It is desired to avoid sanding down the nose of the leading edge. The thickness here is critical to the erosion resistance of the coating. The sides of the leading edge can be sanded smooth if the topcoat thickness is too great. If the thickness is not enough, simply sand it by using the sanding screen to remove the topcoat debris.

In cases where more extensive topcoat is peeled off, a careful sanding along the topcoat-basecoat boundary line may be needed. Once clogged or worn, the used sand paper can be trimmed or torn apart to expose new section of the sand paper. The 4.5″ length of sand paper can be reused for many times. For wider surface, the 4.5″ width can be used to wrap around the sanding sponge. The sanding sponge provides a cushioned sanding surface. Although the sand paper is 150 to 180 grits, it is more abrasive than the 100-grit sanding sponge.

After sanding, the coated blade surface should be wiped clean with the special coated blade solvent included in the kit. Suitable solvents include odorless mineral spirits, VM&P naphtha and MIL-PRF-680 type solvents. After solvent cleaning, the coated blade can be sprayed with the Repair Topcoat with a disposable spray gun. Other methods can be used including the use of paint roller, painting pad or brushing to apply the topcoat. Other typically painting process known to the person skilled in the art can also be used.

The kit may also be used to repair 2-Layered coated article, comprising only the primer layer and the topcoat layer.

### Additional Repair Kit Variations:

In addition to the above, the kits may contain additional contents for use to repair a more extensive damage on the 3-layered coated articles. The additional contents may include:

Repair Topcoat, two or three parts system.

Repair Basecoat

Repair Primer

Syringe with water or water/solvent solution for addition into the Repair Topcoat during mixing.

Anti-fog Safety Goggle

Gloves

Disposable (Preval) Spray Gun with 6 oz plastic bottle

Sanding screen, various grit sizes, 80 grits, 100 grits, 150 grots, 180 grits, 220 grits, grits, or finer. precut to 4.5″×5.5″ or other sizes

Sanding sponges of 100 grit and other grit sizes,

Sanding blocks,

Sanding paper, 80 grits, 100 grits, 120 grits, or finer. high flexibility, precut to 3″×4.5″ or other sizes

Lint free clean wipes

Can Opener for opening container

Cleaning solvent for coated blades Optional brushes may be included to paint damage sites smaller than ⅛″ in width or diameter at the leading edge or on coated airfoil surfaces, such as Microbrush (trade name), Ultrabrush (trade name) or similar, dental brushes.

Wider brushes can be used for larger surface area, such as ½″ wide, 1″ wide, to 24″ wide or even wider (such as for wind mill blade repairs)

Paint rollers to roll repair primer/basecoat and topcoat onto the airfoils, or painting pads of various sizes (Large surface repair such as windmills)

Paint sprayer of various designs can be used.

Flexible applicator (FA) as describe above may be included when basecoat repair is needed.

Sand paper 60-320 grit sizes can be used, especially preferred are 80 grits, 150, 180 and 220 grits.

To assist application, the sand paper may be supplied with self-stick pressure sensitive adhesive, release liner backing, or 3M Hookit design, Stick & Sand design, or in the forms of a Sanding block, Sanding pad, Sanding foam block.

When repairing the small or large eroded area, the brushes can be used to paint multiple layers of the repair basecoat to build up the thickness (for example, 0.014″ to 0.018″ dry film or other thickness needed). The repair basecoat may be brushed on one coat, then wait for it to dry, and then repeat for as many coats as needed to build up the coating thickness to less than final basecoat thickness. Then use flexible applicator (FA) to smooth out the repair basecoat. The FA can be used to “hug” the contour of the leading edge of the airfoil, or it can be used on a flat area of the airfoil body. If it is on the flat side, it can be used like a scrapper. In either case, the FA is used to rebuild the surface contour to the original airfoil surface.

The above repair kits can be used to repair a coated airfoil substrate, such as helicopter rotor blade, wind mill blades, propeller blades, hydrofoils, turbine blades, aircraft wings, radomes, nose cones, fan blades, etc.

While solvent stripping is not the preferred method for field repair, the repair methods disclosed in the embodiments herein are compatible with the solvent stripping coating removal method in the proper work environment. For example, solvent stripping in combination with the repair method embodiments can be practiced satisfactorily in a depot facility. For certain substrates such as radomes, sand blasting or other specialized media blasting techniques may be used to remove damaged material prior to repair as described in various embodiments herein.

Although the embodiments set out herein disclose the methods and materials for use in the airfoil repair procedures, it is readily apparent that the methods and materials embodied can be applied to new erosion protection systems for use on various airfoil leading edge surfaces which benefit from elastomeric erosion protection.

What is claimed is:

1. An elastomeric erosion protection article for an airfoil having a leading edge and trailing edge surface comprising:
a preformed and precured cover having an interior surface complementary in three dimensional shape to the leading edge and trailing edge surface of the airfoil having a basecoat layer; and
an overlying integral topcoat layer.

2. The elastomeric erosion protection article of claim 1 wherein said preformed and precured cover further comprises an underlying integral primer layer positioned under said basecoat layer forming said interior surface complementary in three dimensional shape to the leading edge and trailing edge surface of the airfoil.

3. The elastomeric erosion protection article of claim 1 wherein said basecoat layer is a continuously tapering basecoat layer with a thicker cross section at the leading edge and a thinner cross section in the direction of the trailing edge.

4. The elastomeric erosion protection article of claim 1 wherein said topcoat layer is a continuously tapering topcoat layer with a thicker cross section at the leading edge and a thinner cross section in the direction of the trailing edge of the airfoil positioned over said basecoat layer and forming an outer surface of said preformed and precured cover.

5. An elastomeric erosion protection article for an airfoil having a leading edge and trailing edge surface comprising:
a preformed and precured cover having an interior surface complementary in three dimensional shape to the leading edge and trailing edge surface of the airfoil having a basecoat layer; and
an underlying integral primer layer positioned below said basecoat layer and forming said interior surface.

6. The elastomeric erosion protection article of claim 5 wherein said preformed and precured cover further comprises an overlying topcoat layer forming an outer surface of said preformed and precured cover.

7. The elastomeric erosion protection article of claim 6 wherein said overlying topcoat is a continuously tapering topcoat layer with a thicker cross section at the leading edge and a thinner cross section in the direction of the trailing edge of the airfoil.

8. The elastomeric erosion protection article of claim 1 wherein said basecoat layer is a hand sandable elastomeric material having a sand erosion rate, expressed as mass weight loss, of greater than 0.024 grams and said topcoat is configured to have a sand erosion rate of less than 0.020 grams.

9. A method for protecting an airfoil having a leading edge and trailing edge surface from sand and water erosion comprising the steps of:
a) applying to said leading edge surface a preformed and precured covering comprising a continuously tapering basecoat layer having a thicker cross section at the leading edge and a thinner cross section at the trailing edge of the airfoil having an interior surface complementary in three dimensional shape to the leading edge and trailing edge surface of the airfoil and an underlying primer layer;
b) bonding said preformed and precured covering to said leading edge and trailing edge surface with the primer layer adhered to the airfoil surface; and
c) applying a sand erosion resistant topcoat overlying said preformed and precured covering.

10. The method according to claim 9 wherein said c) applying step comprises rolling, brushing or spraying a plurality of layers to form said sand erosion resistant topcoat.

11. A method for protecting an airfoil having a leading edge and trailing edge surface from sand and water erosion comprising the steps of:
a) applying to said leading edge surface a preformed and precured covering comprising a continuously tapering basecoat layer having a thicker cross section at the leading edge and a thinner cross section at the trailing edge of the airfoil having an interior surface complementary in three dimensional shape to the leading edge and trailing edge surface of the airfoil, an overlying topcoat layer and an underlying primer layer; and
b) bonding said preformed and precured covering to said leading edge and trailing edge surface of said airfoil.

12. A method for protecting an airfoil having a leading edge and trailing edge surface from sand and water erosion comprising the steps of:
a) spraying a primer layer onto said airfoil;
b) spraying over the primer layer a continuously tapering basecoat layer having a thicker cross section at the leading edge and a thinner cross section at the trailing edge of the airfoil; and
c) spraying over said continuously tapering basecoat layer to form an overlying topcoat layer.

13. The method according to claim 12 wherein said overlying topcoat layer has a thicker cross section at the leading edge and a thinner cross section at the trailing edge surface of the airfoil.

14. A helicopter rotor blade subjected to high speed impingement of sand and debris entrained in a fluid having a leading edge and trailing edge surface protected by a preformed and precured covering comprising:
a preformed continuously tapering basecoat layer having a thicker cross section at the leading edge and a thinner cross section at the trailing edge of the airfoil having an interior surface complementary in three dimensional shape to the leading edge and trailing edge surface of the airfoil;
an overlying continuously tapering topcoat layer with a thicker cross section at the leading edge and a thinner cross section in the direction of the trailing edge of the airfoil positioned over said continuously tapering basecoat layer and forming an outer surface of said preformed and precured cover; and
an integral primer layer positioned under said continuously tapering basecoat layer forming said interior surface complementary in three dimensional shape to the leading edge and trailing edge surface of the airfoil.

15. The helicopter rotor blade according to claim 14 selected from the group consisting of windmill blades, turbine blades, runner blades, fan blades, compressor blades, propeller blades, vanes, stay vanes, hydroelectric turbines, marine propellers, hydro turbines, gas turbines, tide mills, windmills, compressors, pumps, blower, impellers, propellers, and fans.

16. An elastomeric airfoil erosion protection coating for an airfoil having a leading edge and trailing edge surface adapted for visual detection of water and sand erosion damage comprising:
a) an adhesive or primer layer of a first color applied directly on a structural substrate of said airfoil surrounding a leading edge of said airfoil;
b) a continuously tapering basecoat layer having a thicker cross section at the leading edge and a thinner cross section at the trailing edge of the airfoil having an interior surface complementary in three dimensional shape to the leading edge and trailing edge surface of the airfoil of a second color selected from the group consisting of a preformed molded boot or a spray applied boot having a shape complementary to said leading edge of said airfoil, a preformed elastomeric sheet and a preformed elastomeric tape applied over said adhesive layer; and
c) a topcoat of a third color on top of said basecoat, wherein said first color, second color and third color are contrasting colors allowing visual detection of damage to said protection coating by visual inspection to detect the appearance of the second color of said basecoat or first color of said adhesive layer indicating damage in the area.

17. The elastomeric airfoil erosion protection coating of claim 16 wherein said topcoat has a thicker cross section at the leading edge and a thinner cross section in the direction of the trailing edge of the airfoil.

18. An airfoil repair kit comprising:
an elastomeric repair topcoat; and
a sanding screen with open mesh.

19. The airfoil repair kit according to claim 18 further comprising one or more components selected from the group consisting of a primer, a sanding disc, sandpaper, sanding sponge, a primer, an elastomeric basecoat, a brush, a paint roller and a disposable sprayer.

20. The airfoil repair kit according to claim 18 further comprising:
a syringe for delivering moisture into the repair topcoat.

21. The airfoil repair kit according to claim 18 further comprising:
a flexible applicator capable of conforming to a leading edge surface of an airfoil; and
an elastomeric, hand sandable basecoat repair material.
